(19) United States
(12) Patent Application Publication
(10) Pub. No.: US 2020/0231227 A1
(43) Pub. Date: Jul. 23, 2020

(54) TEXTILE TIRE FOR LOWERING THE DRAG OF VEHICLES

(71) Applicant: Alpha Team GmbH, Aachen (DE)

(72) Inventors: Abdullah JABER, Aachen (DE); Mohamed FEZAZI, DE (DE); Helga ROHS, Aachen (DE); Jan SCHLIPF, Aachen (DE); Basem ABDELFATTAH, Muenchen (DE); Mugahid MAZYEK, Alsdorf (DE); Atifa BUTT, Aachen (DE)

(73) Assignee: Alpha Team GmbH, Aachen (DE)

(21) Appl. No.: 15/755,612

(22) PCT Filed: Sep. 1, 2016
(86) PCT No.: PCT/DE2016/100401

§ 371 Date: Feb. 27, 2018

(30) Foreign Application Priority Data
Sep. 1, 2015 (DE) 10 2015 011 422.0

(51) Int. Cl. B62D 35/00

(52) U.S. Cl. CPC B62D 35/004

(57) ABSTRACT

A textile tire for lowering the drag of vehicles with a vehicle side and a rear side, wherein a holding device for fastening the textile tire to a vehicle is arranged on the vehicle side, and the textile tire has a filled state and an emptied state, may include a stabilizer arranged in the interior, air ducts provided in the interior, an outer ring on the rear wall, an outlet valve provided on the underside, a suitable sliding guide, and a ventilating device which is driven by the slipstream.

The invention relates to an inflatable textile bag for lowering the drag of vehicles, having a vehicle side and a rear side, wherein a holding apparatus for fastening the inflatable textile bag to a vehicle is disposed on the vehicle side and the inflatable textile bag has a filled and an emptied state.

Inflatable textile bags of this type are known, for example, from DE 31 15 742 A1, from GB 2 148 207 A1, from U.S. Pat. No. 6,409,252, from U.S. Pat. No. 5,236,347, from U.S. Pat. No. 5,058,945, from U.S. Pat. No. 4,978,162, from U.S. Pat. No. 4,702,509, from U.S. Pat. No. 4,601,508, from U.S. Pat. No. 4,236,745, from U.S. Pat. No. 4,006,932, from DE 10 2008 006 365 A1, or from DE 10 2012 011 971 A1.

In this regard, there are, on the one hand, rigid designs as disclosed in DE 10 2008 006 365 A1 or in U.S. Pat. No. 4,236,745, for example. On the other hand, there are many inflatable designs in the state of the art, wherein part of these arrangements function by means of a pumping system that builds up a separate pressure and also evacuates it, as disclosed in GB 2 148 207 A or in U.S. Pat. No. 4,006,932, for example, whereas other systems, as particularly disclosed in U.S. Pat. Nos. 6,409,252, 5,236,347, and 4,978,162 and also various other publications, make use of the travel air stream to build up pressure and then utilize a vacuum pump or natural leakage for evacuation.

It is noteworthy that in spite of the advantages that are evident theoretically and also in practical tests, with regard to energy consumption in vehicles, in particular commercial vehicles, such inflatable textile bags cannot be found on the market.

It is the task of the present invention to provide an inflatable textile bag of the stated type, which minimizes competitive disadvantages of inflatable textile bags which can be found on the market.

The task of the invention is accomplished by inflatable textile bags having the characteristics of the independent claims. Further advantageous embodiments, if applicable also independent thereof, can be found in the dependent claims and the following description.

Thus, very good shape stability of the inflatable textile bag and therefore very good drag characteristics of the inflatable textile bag can be guaranteed by an inflatable textile bag for lowering the drag of vehicles, having a vehicle side and a rear side, wherein a holding apparatus for affixing the inflatable textile bag to a vehicle is provided on the vehicle side, and the inflatable textile bag has a filled state and an emptied state, if the inflatable textile bag is characterized in that a stabilizer that holds its shape but is resilient toward the inside is provided in the interior of the inflatable textile bag, which stabilizer comprises at least one stabilizer surface element having a component that extends perpendicularly toward the surface of the inflatable textile bag, which element is connected with the inflatable textile bag by way of a connection line.

Such a surface element is relatively inherently rigid per se, specifically in its extension plane, while it is flexible otherwise, so that the inflatable textile bag, in the emptied state, takes up the smallest possible amount of space. This accordingly guarantees the flexibility of the stabilizer that comprises the stabilizer surface element, toward the inside.

In this connection, it should be emphasized that the term “inside” refers to the interior of the inflatable textile bag, wherein the interior, depending on the operating state of the inflatable textile bag, is either filled with air or emptied of air to the greatest possible extent. The outside of the inflatable textile bag, in contrast, is subject to atmospheric pressure, if applicable also taking into consideration surface effects, which could also lead to local pressure fluctuations with regard to air pressure, due to differences between stationary air and moving air, for example, and this could represent to pressure differences between the outside air that surrounds the inflatable textile bag and is situated between the rear of a commercial vehicle and a rear wall on the vehicle side, and the outside air on the outer wall of the inflatable textile bag around which the air stream flows.

It is furthermore understood that the filled state is ultimately any state of the inflatable textile bag in which the inflatable textile bag is unfolded in a state sufficient for its drag-lowering task, while the emptied state as such represents a pressure-free state in which the inflatable textile bag can counter possible external forces only with very weak forces and is flaccid as such. Furthermore, it is understood that there are also transition states between these two states, since the air that fills the inflatable textile bag cannot be removed from the inflatable bag at just any desired speed, and, in particular, can be removed only to a certain extent.

It is fairly well known that vehicles, and in particular, also commercial vehicles, have a front side and a rear side, which are solely defined by the direction in which the cabin is oriented. In this regard, particularly in the case of commercial vehicles, the rear side proves to have a disadvantageous configuration in terms of flow mechanics, because it is frequently important to optimize the available cargo space. Specifically at such rear sides, an inflatable textile bag can then be provided, which accordingly has a vehicle side that faces the vehicle, and ultimately also faces the front side of the vehicle, and a rear side that accordingly is also oriented parallel to the rear side of the vehicle.

By its nature, a vehicle, but also an inflatable textile bag, can accordingly be associated with a top side and an underside; this is ultimately clearly defined by wheels and the related road, so that the underside faces the road, i.e. faces in the direction of the wheels, while the top side faces away from the road and from the wheels of the vehicle. Perpendicular to the plane that can be defined by the normal vectors of the vehicle side or front side, the rear side, the top side, and the underside, there are also horizontal sides that can also be referred to as sides in the conventional sense.

Pressure conditions in the interior of the inflatable textile bag can be managed very well, in particular, if the inflatable textile bag has both a rear wall and an outer wall, and therefore if it is completely sealed according to the extent necessary for the filled state, with the exception of possible openings that might be helpful or practical or necessary for operation, such as air inlets and outlets, valve openings or the like.

In this regard, the rear wall is accordingly oriented toward the vehicle side, while the outer wall has a top side, an underside, two horizontal sides, and the rear side.

Preferably, the inflatable textile bag is configured to be airtight, wherein it is understood that because of the use of a textile, which might also be sewn, under some circumstances, air permeability can certainly exist, and can also be consciously accepted, if necessary.

In the present context, the term “textile” refers to surface elements that demonstrate sufficient surface rigidity and surface stability in and of themselves, while they are flexible and movable perpendicular to their surface. In particular, the term “textile” comprises materials that are woven or knitted. But also other inherently rigid scrims, such as knitted structures, for example, which are generally not efficient, however, or knitted fabrics or other structures produced in some other textile manner are conceivable. In the present context, it should be emphasized, however, that film-like materials can be used in this regard, as long as they sufficiently satisfy the demands with regard to their inherent rigidity over their surface area. Primarily, however, textile structures comprise at least one core composed of threads or filaments, which are connected with one another in sufficiently tight manner, wherein interstices can certainly exist between these threads or filaments, which interstices are referred to as meshes in the present case—even if the textile structures are scrims or knitted fabrics.

It is understood that the corresponding basic woven fabric or knitted fabric can also be sealed, if necessary, in order to influence its stability, air permeability or other properties in the desired manner, but this is sufficiently known from the state of the art.

In general, the textile structures selected for the inflatable textile bag will have meshes which are significantly smaller than the diameter of the threads or filaments, in order to already achieve good stability and also the greatest possible air non-permeability of the basic woven fabric or knitted fabric. In particular, the rear wall and the outer wall of the inflatable textile bag are configured in corresponding textile manner, wherein if applicable, slight air permeability through the meshes or also through connecting seams can be tolerated, in particular nearby effects in terms of flow mechanics might be desired, such as a resting air cushion around the inflatable textile bag, for example.

It is understood that the stabilizer surface element can also be configured in textile manner, and thereby it can be adapted, with regard to its mechanical properties, to the mechanical properties of the rear wall or outer wall.

Accordingly, it is advantageous if the stabilizer surface element is configured so that it can move perpendicular to its surface, and this particularly relates to the extent by which the outer wall or rear wall can also be moved in terms of its surface, so that the overall mechanical behavior of the inflatable textile bag appears to be uniform.

Good flexibility of the inflatable textile bag can be guaranteed if the connection line with which the stabilizer surface element, or at least one of the stabilizer surface elements, if multiple such stabilizer surface elements are used, lies in the interior of the inflatable textile bag. The stabilizer surface element then contacts, with one of its edges, a surface of a corresponding surface element of the rear wall or of the outer wall, which surface is intrinsically consistent and inherently stable, and the element is connected there, from the inside, with this surface, in each instance, so that it also has a corresponding stabilizing effect from the inside, without excessively restricting the mobility of the outer wall or rear wall. It is understood that such a configuration does not apply or need to apply to all of the stabilizer surface elements; in particular, however, this has proven to be advantageous in the case of connection lines that have a component perpendicular to the flow direction or perpendicular to the direction of travel of a corresponding commercial vehicle. As a result, this appears particularly advantageous for connection lines that are inclined by more than 15° or more than 20° relative to the flow lines that flow past them.

While the rear wall and outer wall of the inflatable textile bag should be configured to be sufficiently airtight so as to be able to maintain a sufficient pressure in the filled state, this is generally not necessary for the stabilizer surface elements, since these are disposed in the interior of the inflatable textile bag. In this regard, it is conceivable to use a different type of textile here, and this appears to be practical particularly for reasons of cost, since corresponding air-permeable materials are generally significantly more cost-advantageous than air-impermeable materials. In this regard, textile surface structures with larger meshes can also be used as stabilizer surface elements, and this, in particular, increases the air permeability of the stabilizer surface elements and consequently of the stabilizer, and as a result, any chambers that occur in the interior of the inflatable textile bag due to the stabilizer surface elements can be evacuated and aerated more uniformly. In this context, it is understood that the dimension of the meshes is limited, in particular, by the required inherent rigidity over the surface of the respective stabilizer surface elements.

The latter is a possible reason why sufficiently uniform aeration and evacuation of chambers formed by the stabilizer surface element cannot be guaranteed. Thus, it is advantageous if the stabilizer surface element has at least one hole. Sufficient air exchange can then be guaranteed by means of such a hole or a plurality of such holes. Naturally, such a hole does not extend all the way to an edge of the respective stabilizer surface element, so that a continuous connection line to the outer wall and/or the rear wall can be guaranteed per se, in spite of any holes. Exceptions to the continuity can be found in certain corners and edges if curvature radii prevent a continuous connection line here. In this case, it is advantageous if such interruptions in the connection line are smaller than the radius of the holes, since it can then be assumed that the influence on the inherent rigidity of the stabilizer surface elements is essentially determined by the hole or holes and not by smaller structurally necessary interruptions of the connection line.

The size and placement of the hole or holes are selected in such a way that sufficiently stable tension lines remain around the hole or holes, along the surface of the surface element, so that the stabilizer surface element continues to remain sufficiently inherently rigid, in terms of its surface. If necessary, the edge of the hole can also be slightly reinforced, so that the tension lines can be conducted around the holes or hole to a sufficient extent.

However, when the inflatable textile bag is collapsed, such holes may also be covered, under some circumstances, by other surface elements or by the surface element that has the hole and is being folded in some manner, and therefore it might no longer be possible to guarantee sufficient aeration and evacuation. In order to prevent this, it is advantageous if at least one air channel having openings into the inflatable textile bag is disposed in the interior of the inflatable textile bag, so that aeration and evacuation can be optimized by means of the number of openings that the air channel provides, and by means of the reliable air flow that is made possible by the air channel.

In this context, it is understood that even independently of the remaining characteristics of the present invention, good aeration and evacuation can also be guaranteed, in particular, in all operating states of the vehicle, such as, for example, in the event of emergency braking if rapid deflation occurs, by means of an inflatable textile bag for lowering the drag of vehicles, having a vehicle side and a rear side, wherein a holding apparatus for fastening the inflatable textile bag to a vehicle is disposed on a vehicle side, and the inflatable textile bag has a filled state and an emptied state, if the inflatable textile bag is characterized in that at least one air channel having openings into the inflatable textile bag is disposed in its interior.

Such an air channel can, in particular, guarantee an exchange between any air chambers inside the inflatable textile bag. Depending on specific requirements, however, it can be connected directly to an aeration and/or evacuation system, if necessary, and thereby also serve as an overall means of aeration and evacuation. It is understood that multiple air channels can also be provided, in simple manner, in terms of design, which channels are acted upon separately, in order to thereby be able to preferentially aerate or evacuate specific chambers.

The air channel is preferably formed by an air hose, since such a hose has a certain inherent mobility, and this promotes the basic properties of an inflatable textile bag, which is intended to be collapsed in the emptied state.

In particular, it is advantageous if the air hose is inherently stable, so that even in the event of collapse, an air channel located in the air hose is not impaired.

It is understood that instead of an air hose, pipes that might be movably connected with one another, or other more complex structures, such as u-shaped rails or the like, can be used for forming an air channel.

A perforated air hose is particularly preferred, because due to the plurality of openings it guarantees homogenous aeration and evacuation, even if some of its openings might be covered by some material of the inflatable textile bag.

The at least one stabilizer surface element can contact the rear wall or the outer wall of the inflatable textile bag at its connection line, so as to have a corresponding shape-stabilizing effect in this manner. In this regard, it is understood that a seam or supplemental transition elements or connection elements can be provided at the butt joint, so as to guarantee a sufficiently stable connection here.

Preferably, the stabilizer surface element comes into contact with the rear wall and/or the outer wall of the inflatable textile bag with a perpendicular component, so that the stabilizing effect can be developed particularly effectively.

If the rear wall or the outer wall is also formed by textile surface elements, in the present case called inflatable bag surface elements, the stabilizer surface element can be connected with two of the inflatable bag surface elements that form the rear wall or the outer wall. In this way, it has a particularly stabilizing effect, since it can force the desired shape to occur between these two inflatable bag surface elements. If the outer wall is formed by at least two inflatable bag surface elements, the same holds true for a stabilizer surface element that is connected with both of these inflatable bag surface elements.

A particularly stable configuration is achieved if the at least one stabilizer surface element is at least connected with the rear wall, and connected with the outer wall at least on at least two of its edges. This brings about the result, in particular, that the rear wall can also be shaped in correspondingly stable manner. This also brings about the result that the overall arrangement remains relatively stable, in particular even if pressure is built up from the inside, in other words the inflatable textile bag is in its filled state, and when travel air stream flows around the inflatable textile bag.

A particularly stable configuration occurs if the stabilizer surface element is connected with the outer wall on at least three of its edges, and with the rear wall on its fourth edge, so that it can have a shaping effect all around.

From this, it follows directly that the stabilizer surface element divides the interior of the inflatable textile bag, if applicable, and thereby the chambers that have already been mentioned above can occur.

It is understood that, if necessary, a stabilizer surface element can be composed of a plurality of partial surface elements, and this can be particularly advantageous if two stabilizer surface elements intersect, wherein then, one of these stabilizer surface elements is divided at the intersection line, while the second of these stabilizer surface elements then preferably should be configured to be continuous, at the intersection line, in particular for reasons of stability; however, it can also be divided at the intersection line, if necessary. By means of a connection, which is preferably configured in linear manner, the partial surface elements can be assembled to form the respective stabilizer surface elements.

Such an intersection can be used advantageously, in particular, if a central element is used as a stabilizer surface element that divides the inflatable bag in the vertical direction, wherein then, in particular, either the central element or the intersecting stabilizer surface element can be divided and re-assembled at the connection.

Precisely then, both the central element as one of the stabilizer surface elements, and the stabilizer surface element that intersects the central element, can easily be configured in that they are connected with the outer wall with three of their edges, in each instance, and with the rear wall with the fourth edge.

As already indicated above, the corresponding connection lines are preferably continuous, so as to guarantee the best possible distribution of strain and very great of the stabilizer.

In the filled state, the stabilizer surface element is preferably subject to constant tension, so that it can withstand the forces that are applied to it in particularly stable manner. In the case of constant tension, no abrupt changes occur in the tension lines in the respective stabilizer surface element, so that the respective stabilizer surface element can withstand the forces exerted on it in correspondingly stable manner. In particular, such a stabilizer surface element is therefore not subject to any discontinuities in the tension, as they occur, for example, due to point loads or kinks.

The stabilizer surface element remains particularly inherently rigid and can therefore absorb relatively great forces if it is connected with other stabilizer surface elements or with inflatable bag surface elements only at its edges. This guarantees that loads that act perpendicular to the surface of the stabilizer surface element can be reduced to a minimum. If, however, a connection is also made at the surface, it is advantageous if not only one but two connections with two further surface elements, each disposed at opposite surface sides of the respective stabilizer surface element, are present on this line, so that the forces of the two surface elements compensate one another—specifically with regard to their components perpendicular to the plane of the corresponding stabilizer surface element, which is connected with other surface elements in terms of its surface: This can be advantageous, in particular, in conjunction with the use of a central element.

As already explained above, if the associated stabilizer surface elements are suitably configured, wherein here, their length in relation to the rear wall and also their shaping effect with regard to the rear wall plays a role, then it can be ensured, by means of the inner stabilizer, that the rear wall does not exert any unnecessary forces on the rear of the vehicle when the inflatable textile bag is filled, something that can particularly occur if the rear wall is also acted on by the internal pressure of the inflatable textile bag. In particular, it can be ensured, by means of the rear wall that is curved inward, in other words facing away from the rear of the vehicle, that even smaller structures on the rear of the vehicle, such as fittings or door handles or the like, remain free or without stress, to a great extent, and do not exert any forces on the inflatable textile bag, if the inflatable textile bag, on its vehicle side, has a textile rear wall that is curved inward in the filled state.

It is advantageous per se if this curvature is as great as possible, since this serves for a reduction of the total volumetric capacity of the inflatable textile bag, which in turn allows more rapid aeration or evacuation. On the other hand, if the curvature of the rear wall is too deep, the overall stability of the inflatable textile bag can be decreased, in particular also in the case of the presence of or in spite of a stabilizer disposed within it, so that the depth of the curvature should not be selected to be overly great. Such instabilities can particularly occur in that the stabilizer can then only act on the rear wall at less advantageous angles.

In practice, it has been found that in the filled state, a curvature between the vehicle side and the rear which is greater than 5% of the length of the inflatable textile bag can be advantageous. Values of up to 20% can also be used in this regard, in particular if shorter inflatable textile bags are utilized, which are also subject to lower lateral forces.

On the other hand, it is advantageous if the inflatable textile bag makes a transition into the rear of the vehicle as seamlessly as possible in the region of the transition between the rear of the vehicle and the outer wall, if only in order to guarantee the most undisturbed transfer possible of the air masses that flow past the side surfaces and the vehicle roof to the inflatable textile bag. For this purpose, it is advantageous if the rear wall is sufficiently intrinsically stable and can absorb corresponding forces, since otherwise the corresponding forces have to be applied to the rear of the vehicle exclusively by way of the connecting structure, and therefore the textile structures at the transition to the connecting structure are also exposed to stress, and this can be guaranteed by textile materials only with great difficulty, in particular over the required period of operation. In this regard, it is advantageous if the inflatable textile bag has a textile rear wall comprising a stabilized outer ring on its vehicle side. In this regard, the outer ring can then absorb and compensate any transverse and/or tensile forces at least up to a certain degree, before these forces get into the connecting structures to the rear of the vehicle.

Accordingly, an inflatable textile bag for lowering the drag of vehicles, having a vehicle side and a rear side, wherein a holding apparatus for fastening the inflatable textile bag on the vehicle is disposed on the vehicle side, and the inflatable textile bag has a filled state and an emptied state, is advantageous even independent of the remaining characteristics of the present invention, if the inflatable textile bag is characterized, on its vehicle side, by a textile rear wall that comprises a stabilizing outer ring.

In this regard, the depth of the previously described curvature of the rear wall can preferably be configured between half and twice the width of the outer ring, and this proves to be advantageous for reasons of stability and for the reasons already mentioned above.

The outer ring is preferably connected with or worked into the rear wall in planar manner, so as to be able to interact with the rear wall accordingly. Planar interaction with the outer wall can also be implemented with a corresponding embodiment, and advantageously has a corresponding stabilizing effect and guarantees a good connection. Accordingly, the outer ring can also be connected with the outer wall in planar manner or can be worked into the outer wall.

The outer ring can be made from woven nylon fabric or woven steel fabric, for example, which fabric per se still has a certain flexibility, so that the inflatable textile bag as a whole retains its textile character in a certain manner and can, for example, still be folded up or drawn around edges; this is advantageous, for example, if the rear of the vehicle is to be freely accessible for loading purposes or for similar reasons. It is then possible to fold the inflatable textile bag to the side, for example, or also to push it around an edge of the vehicle.

Accordingly, it is advantageous if the outer ring is configured to be flexible.

Also, independent of the remaining characteristics of the present invention, an inflatable textile bag for lowering the drag of vehicles, having a vehicle side and a rear side, wherein a holding apparatus for fastening the inflatable textile bag to a vehicle is disposed on the vehicle side and the inflatable textile bag has a filled and an emptied state, can be characterized in that an outlet valve is provided on a bottom side of the inflatable textile bag.

Valves as such are sufficiently known, in particular for filling and emptying, and can also be expected technically. However, since they generally have to be accessible for maintenance work, such as connecting pressure hoses or for manual evacuation of air, or are supposed to take in air at the horizontal sides or the top side of the vehicle, so as to guide this air into the interior of the inflatable textile bag, there have not been any valves—and, in particular, outlet valves —on the underside of inflatable textile bags to date.

On the other hand, the outlet valve provided on the underside of the inflatable textile bag makes it possible for the first time to easily remove from the inflatable textile bag possible accumulations of undesired substances within the inflatable textile bag, by way of the outlet valve.

Even when filling the inflatable textile bag with compressed air by machine, but in particular if the inflatable textile bag is filled by way of the travel air stream, dirt particles, water, condensate and, in particular, organisms get into interior of the inflatable textile bag and, over time, this leads to excessive contamination, which requires very complicated removal to date. Undesired materials in the interior of the inflatable textile bag can be easily removed by way of the outlet valve; this applies, in particular, for water, which collects in the inflatable textile bag as condensate or also by introduction by the travel air stream and, after only a very short time, also serves as a nutrient source for microorganisms. If such an accumulation of water can be prevented, it is possible to avoid complex cleaning procedures or an overly short service life of the inflatable textile bag.

The outlet valve is preferably disposed at the lowest point of the underside of the inflatable textile bag in the filled state, so that undesirable substances are discharged due to gravity, or also by an air stream that escapes from the inflatable textile bag, supported by gravity. In this regard, it is understood that a small overhang, such as, for example, a seam around the corresponding outlet valve or even smaller volumes that may lie even deeper, can certainly be accepted as long as only very small quantities of liquid can collect there, which are insignificant in quantity or then evaporate on warmer days, for example, or can be driven out of such sinks by the natural movements of the inflatable textile bag during travel or the transitions between the filled state and the emptied state or due to similar movement processes.

The outlet valve is preferably configured in passive manner, and this leads to the result that it ultimately opens autonomously when emptying processes are to take place, and closes when this appears practical for other reasons. In this way, complex control processes as well as units required for them can be omitted.

Thus, the outlet valve can be configured in the form of a check valve, which opens outward in the event of excess pressure, so that the outlet valve is open when the inflatable textile bag is filled, and any disruptive substances can easily leave the bag. Any leakage current caused by this can be restricted to a relatively small size, since the outlet valve can ultimately remain constantly open during travel, and thereby a sufficient quantity of undesirable material can be discharged solely over the time period of opening.

Furthermore, it can be assumed that a certain leakage of the inflatable textile bag as a whole will be present in any case, for example through minute holes caused by minor damage, or also through seam locations, so that it is advantageous, in any case, to design the system correspondingly generously with regard to the amount of air supplied to it, and accordingly, corresponding leakage current is, then acceptable.

If, on the other hand, the inflatable textile bag is to be emptied quickly, something that can be necessary, in particular, in the case of strong braking processes or in other operating states, for example in the event of contact with a foreign body, such as another vehicle or a wall, at the rear of the vehicle, a check valve closes automatically under the forces of a partial vacuum having a suction effect, and makes it possible to build up a relatively strong partial vacuum, which causes the inflatable textile bag to collapse quickly.

However, a weight-controlled valve can also be used as an outlet valve, in passive manner, which valve opens if a weight load on it is caused by dirt, water or the like, taking into consideration the internal pressure prevailing in the interior of the inflatable textile bag, which pressure can also be compensated, if necessary, by way of a compensation line to the valve. If the mass load on the valve is reduced to a sufficient extent, the valve then closes again.

A particularly simple construction of an outlet valve may be presented by an implodable hose, which is open at excess pressure and contracts in a partial vacuum, and thereby closes the opening.

The holding apparatus already mentioned above serves to fasten the inflatable textile bag on a vehicle. While the inflatable textile bag as such is movable and foldable to a certain degree, the holding apparatus provides essentially rigid modules, which are connected with the vehicle in fixed but possibly releasable manner, so as to guarantee operationally reliable fastening. In this regard, it is understood that certain modules of the holding apparatus can also be connected with the vehicle in non-releasable manner, or can be integrated into the vehicle.

It is true that commercial vehicles that do not necessarily need to be accessed from the rear, for example vehicles that are loaded or unloaded from above or from the side, for example, are also conceivable. However, if access to the rear of the vehicle or to a trunk of the vehicle is supposed to be made possible, it is advantageous if the inflatable textile bag can be removed and, consequently, the holding apparatus can be released.

On the other hand, it proves to be relatively complicated to completely remove the inflatable textile bag from the rear of a vehicle for possible loading processes that take place by way of the rear of a vehicle, so that collapsing or folding possibilities for such inflatable textile bags are already known from the state of the art.

A less space-consuming possibility for guaranteeing access to the rear of a vehicle, even independent of the remaining characteristics of the present invention, makes possible an inflatable textile bag for lowering the drag of vehicles, having a vehicle side and a rear side, wherein the holding apparatus comprises a holding device for fastening the inflatable textile bag to a vehicle is disposed on the vehicle side and the inflatable textile bag has a filled and an emptied state, if the inflatable textile bag is characterized in that the holding apparatus comprises a fixed holding device on the vehicle side and a displaceable sliding guide on the inflatable textile bag side.

The inflatable textile bag can then be moved along the holding device by way of the sliding guide, and consequently can also be displaced along the rear side of the vehicle, so as to obtain access to the vehicle rear or to bring the inflatable textile bag back into its position on the rear again in operationally reliable manner.

Preferably, the sliding guide can be displaced upward, since then the inflatable textile bag does not hinder further activities in the region of the rear of the vehicle, since such activities are generally not carried out at the top side of the vehicle, but rather at most at the horizontal sides and, of course, at the rear. On the other hand, during travel the inflatable textile bag is provided at the rear of the vehicle, so that any increase in height of the vehicle cross-section is not critical, since an inflatable textile bag pushed to the side will only be present when the vehicle is standing still.

A sliding block guide, for example, in which sliding blocks or sliding block wheels run in a guide, can be used as a sliding guide. Such a sliding block guide can be configured to be relatively rigid and can also absorb relatively high forces, so that in this manner, the inflatable textile bag can be kept in its position, in operationally reliable manner, during travel.

The same is also possible by way of a keder guide, which can accordingly be used as a sliding guide.

In particular, the keder guide can have two first keder rails on the holding device side, which are spaced apart from one another by the width of the vehicle side and extend over the height of the vehicle side and, on the inflatable textile bag side, two keders disposed in the first keder rails, at least in the filled state of the inflatable textile bag. This brings about the result that the inflatable textile bag is held in correspondingly stable manner over its entire vehicle side when it is in its position to be assumed for travel.

The orientation of the two keder rails brings about the result that the inflatable textile bag can be displaced upward or downward, wherein in particular, as already mentioned above, displacement upward is advantageous.

Alternatively, the keder guide can have two first keder rails on the holding device side, which are spaced apart from one another by the height of the vehicle side and extend over the width of the vehicle side, in which rails two keders are disposed in the filled state of the inflatable textile bag, and this then allows accordingly displacement toward the horizontal side.

The two keder rails are therefore preferably oriented in a first plane that lies parallel to the vehicle side.

The keder guide can now have two second keder rails, which are disposed in a second plane that is angled away relative to the first plane, wherein one of the second keder rails, in each instance, is associated with a first keder rail and with the related keder, and the keder can run from the first keder rail to the second keder rail and back again. Such an embodiment makes it possible that the inflatable textile bag can be displaced, in operationally reliable manner, into a position on a horizontal side of the vehicle or on the top side of the vehicle, so as to expose the rear side of the vehicle, so that the inflatable textile bag remains on the vehicle in operationally reliable manner even if the vehicle rear is exposed, and this, in particular, helps to prevent damage or also possible losses.

In order to reduce possible threading processes to a minimum at the transition from the two first keder rails to the two second keder rails and back, the keder rails can open somewhat wider, for example at the transition. It is also possible to open the keder rails entirely if suitable insertion angles are provided and the keder can be transferred from the one keder rail into the other keder rail in operationally reliable manner, in each instance.

Preferably, a curved keder rail is disposed between at least one of the two first keder rails and the associated second keder rail, so that possible threading processes can be eliminated entirely, and the first and the second keder rail, in each instance, form a common keder rail together with the curved keder rail, in each instance.

In order to relieve stress on the inflatable textile bag and, in particular, also on a keder flap of the keder guide, which flap is connected with the inflatable textile bag, it is advantageous if the curved keder rail is inclined in the direction of the curvature. In this regard, inclination angles of up to 30° prove to be advantageous. In this manner, excessive stresses can be avoided in the transition between the two keder rails, and this accordingly results in an increase in the service life of the inflatable textile bag.

In practice, a keder flap which encloses a keder bead of the keder guide and which is connected with the inflatable textile bag allows a sufficiently stable but also sufficiently flexible connection between the inflatable textile bag and the holding device or the vehicle, wherein in particular, the most seamless transition possible between the vehicle sides and the inflatable textile bag can also be guaranteed.

It is understood that other sliding guides can also be constructed in similar manner, such as, for example, the sliding block guides described above. Here, too, guide rails can be provided on both sides of the inflatable textile bag, in each instance, which rails are angled, if necessary, and, in particular, can also be inclined at the angle, so that the inflatable textile bag can be displaced parallel to a vehicle side.

The keder arrangement described above, comprising at least one keder rail and, on the inflatable textile bag side, at least one keder bead disposed in the keder rail, which bead is enclosed by a keder flap, which ultimately creates the connection to the remainder of the inflatable textile bag, makes it possible, also independent of the other characteristics of the present invention, in the case of an inflatable textile bag for lowering the drag of vehicles, having a vehicle side and a rear side, wherein a holding apparatus for fastening the inflatable textile bag to a vehicle is disposed on the vehicle Side, and the inflatable textile bag has a filled state and an emptied state, to fasten the inflatable textile bag to the vehicle in very stable and material-protecting manner. This also holds true, in particular, even if no sliding guide is provided at all.

Other types of rails, which allow a connection over long distances, can also be used to corresponding advantage in the case of an inflatable textile bag for lowering the drag of vehicles, having a vehicle side and a rear side, wherein a holding apparatus for fastening the inflatable textile bag to a vehicle is disposed on the vehicle side, and the inflatable textile bag has a filled and an emptied state.

In particular, the rails can carry a first component of a two-component holder, such as, for example, a tongue of a tongue-and-groove connection or hooks or loops of a hook-and-loop connection, so as to be able to connect the inflatable textile bag with the second component of the corresponding two-component holder on the rear side of the vehicle, in other words with the groove of the tongue-and-groove connection or with corresponding hooks or loops of the hook-and-loop connection, for example.

Also, even independent of the remaining characteristics of the present invention, a holding apparatus of an inflatable textile bag for lowering the drag of vehicles, having a vehicle side and a rear side, wherein a holding apparatus for fastening the inflatable textile bag to a vehicle is disposed on the vehicle side, and the inflatable textile bag has a filled state and an emptied state, allows stable but also releasable fastening of the inflatable textile bag for maintenance or other work, if the inflatable textile bag is characterized in that the holding apparatus comprises a tensioning apparatus that has a tensioned and a relaxed position, and acts on the inflatable textile bag parallel to its rear side. Such a transition from a tensioned to a relaxed position can be brought about very quickly, so as to be able to carry out maintenance work, if necessary. On the other hand, the tensioned position allows precise positioning of the inflatable textile bag during travel.

The tensioning apparatus can, in particular, be configured as a quick-action tensioning apparatus, in order to be able to accelerate the work processes accordingly.

In particular, the tensioning apparatus can comprise a tensioning lever, since this allows simple and operationally reliable handling.

If the holder and the tensioning apparatus have common modules, such as, for example, a tensioning lever that also opens and closes the holder, or a holding clip that also acts in tensioning manner, operation of the inflatable textile bag can be further simplified and also configured to be more operationally reliable.

In order to protect the sliding guide from unnecessary transverse stresses and improper use, it is advantageous if the sliding guide has a drive. This drive can then also be configured manually, for example, by means of activation of a crank as the drive of a slider, for example. However, the drive is preferably motor-driven, and this, in particular, also reduces the physical stress for the operating personnel.

In particular, the drive can be effective on both sides of the inflatable textile bag, parallel to the rear side, so that any possible distortion can be reduced to a minimum.

In a practical implementation, such parallel effectiveness can be guaranteed by different measures. For example, two separate partial drives can be provided, which are coupled by way of a common rod. Thus, a toothed belt, a cable pull or the like can be provided, for example, on both sides of the inflatable textile bag, in a correspondingly effective manner, wherein the corresponding drives can then be coupled with one another by way of a common shaft or the like. It is also conceivable to provide a circumferential total pull that encloses both sides of the inflatable textile bag and which has a cross-over traction guide, as a result of which corresponding sliding forces can be applied to both sides of the inflatable textile bag by means of a single drive location.

In particular, the drive can comprise at least two drive motors, wherein one of the drive motors, in each instance, is active on one side of the inflatable textile bag, in each instance.

In this case, too, the two motors can be coupled with one another by way of a common shaft, for example. Preferably, however, the two drive motors are controlled and regulated separately, and as a result, the corresponding vehicle side, on which the drive is provided, is correspondingly relieved of stress.

A particularly simple control method is to control one of the two drive motors as the master and the other of the two drive motors as the slave. This makes it possible that only the drive motor controlled as the master needs to be connected with the overall controller for drive of the inflatable textile bag, while the drive motor controlled as the slave merely needs to follow the movement of the drive motor controlled as the master.

In a concrete implementation, it is conceivable, for example, to move both drive motors, without the inflatable textile bag, clearly below their maximal speed at first, over their required amplitude, as a learning process, and to record the time that the two drive motors require for this. The time of the drive motor controlled as the master is specified as the reference time for the controller of the motor controlled as the slave. Any deviation of the reference time from the actual time can then be corrected by the control unit of the drive motor controlled as the slave, by means of speed adjustments. With these adapted values, both drive motors are then operated under the load of the inflatable textile bag, over their maximal required amplitude. Possible time differences are once again adapted and stored in memory. Afterward, a run at a load close to the maximal speeds of the drive motors should be repeated. Any time differences are correspondingly corrected once again by adapting the drive speed, and stored in memory. From then on, the travel times of the drive motor controlled as the master and of the drive motor controlled as the slave are always compared during operation, and any deviations are adapted.

For flexible adaptation of the two drive speeds a pulse-width-modulated power supply, for example, is practical so as to digitally control the two drive motors by way of a microcontroller. Hall Effect sensors can be used in practical manner for optimum position determination of the inflatable textile bag and for closely timed tracking; these can provide feedback to the control devices at all times and thus, for example, enable monitoring of the drive motors. The associated control systems can be connected, for example, by means of a CAN bus or, alternatively, by means of LAN, by means of WLAN or Bluetooth, wherein in particular, a connection to the vehicle controller or the CAN bus of the vehicle can also take place. The nominal drive speed of the drive motors should be 75% of the maximal power, so that the drive motor controlled as the slave is also able to execute a correction into the upper power range. Corresponding maximal values should, however, be corrected to the nominal value again during the subsequent cycle, so that once again, freedom of movement remains for correction in both power directions.

The mutual just-in-time monitoring of the controller, but also as the closely clocked real-time monitoring of the drive motors can be used for precise adjustment of the motor power of the drive motors, so as to compensate load fluctuations and undesirable vibrations in the system. Temporarily increased friction coefficients of the inflatable textile bag, for example during the transition from the first keder rails to the second keder rails and back, as well as resistance peaks in the system can thus be quickly compensated by the controller, by increasing the respective drive power, so as to guarantee a smooth synchronous drive. The precision monitoring can be utilized as a safety feature for emergency switch-off if a maximal torque is exceeded. Routine utilization of the maximal torque switch-off for determining when the two end positions for moving the inflatable textile bag out toward the rear side or in away from the rear side, for example, would also be practical.

The drive can comprise a directional winding drum, or also two bidirectional winding drums, if necessary, on which a circumferential cable or two oppositely directed cables are alternately wound up. This allows particularly operationally reliable and non-slip drive of the sliding guide or of the inflatable textile bag.

Preferably, the cable is or the cables are configured to be self-tensioning, so that the inflatable textile bag is guided in sufficiently operationally reliable manner in all operating positions, even along the sliding guide.

It is understood that such a self-tensioning configuration of the cable or cables is also advantageous independent of the use of a bidirectional winding drum if such cables are used, for example in the form of Bowden cables.

In particular, cables can be disposed on both sides of the inflatable textile bag, parallel to its direction of movement, so as to enable movement of the inflatable textile bag in both directions in this manner. As already described above, if drives, offset in parallel, perpendicular to the direction of movement, are provided on both sides of the inflatable textile bag, it is accordingly advantageous if a cable is provided, in each instance, not only on both sides in the guiding direction, but also on both guided sides of the inflatable textile bag, so that the inflatable textile bag is guided along the sliding guide in operationally reliable manner on both sides, in both directions.

In this regard, the cables that are disposed on one side of the inflatable textile bag, in a plane parallel to the sliding guide, together with the inflatable textile bag and, if applicable, also with inclusion of a drive carriage or other concurrent modules, can represent a circulating drive cable, and this—also in interaction with a bidirectional winding drum —guarantees a reliable drive connection. If necessary, all the cables can also be combined to form a single circulating cable, so as to be able to guarantee two drives that act synchronously on both sides of the inflatable textile bag, by means of a single drive unit, in this manner, by crossing the cables, as is already known, for example, for drive of window lifters.

It is understood that instead of the cables described above, other drive possibilities, such as toothed belts and/or toothed racks, can be used.

In practice, it has been found that it is just as necessary to quickly vent the inflatable textile bag as to bring it into the filled state in operationally reliable manner with air pressure, and also to keep it in this state. In this regard, as already explained above, some applications propose active emptying of the inflatable textile bag by suction.

If an inflatable textile bag for reducing the drag of vehicles, having a vehicle side and a rear side, wherein a holding apparatus for fastening the inflatable textile bag to a vehicle is disposed on the vehicle side and the inflatable textile bag has a filled state and an emptied state, is characterized in that the inflatable textile bag is connected to a venting device driven by the travel air stream of a motor vehicle, operationally reliable venting at the necessary points in time can be guaranteed, even independent of the other characteristics of the present invention, in structurally simple manner.

When the vehicle is standing still, a filled inflatable textile bag is not necessary in any case, so that there is also no reason to maintain the filled state when the vehicle is standing still. However, in travel situations, in particular if, for example, a rear-end collision is imminent to the vehicle equipped with the inflatable textile bag, sufficiently rapid and operationally reliable emptying can be necessary. This requirement can be correspondingly taken into account in structurally simple and energetically advantageous manner by means of the venting device driven by the air stream.

Due to the fact that moving air by nature has a lower pressure than non-moving air, and due to the partial vacuum that is present at the rear in any case, a venting device can be driven by means of the air stream in structurally very simple manner, in that this partial vacuum situation is utilized in targeted manner for venting. On the other hand, in such open systems as they occur at the outer wall of the inflatable textile bag, the pressure differences are relatively slight, so that it is advantageous to intervene in reinforcing manner in this regard. This can be achieved, in particular, by the use of a Venturi nozzle as a venting device, by means of which a partial vacuum can be generated in targeted manner and can then be used for venting or emptying. Accordingly, it is advantageous if the venting device comprises an air inlet, a Venturi nozzle, and an air outlet. In this way, the air can be captured in targeted manner and used to build up a partial vacuum.

The Venturi nozzle can have a suction chamber that is connected with the interior of the inflatable textile bag, so that emptying of the inflatable textile bag is easily possible in this manner.

In particular, the venting device can be a filling and venting device that is driven by the air stream, i.e. it can serve for both filling and emptying the inflatable textile bag.

For this purpose, it is particularly advantageous if a retention device is provided between the air inlet and the air outlet, which can optionally retain the air that flows through the Venturi nozzle. If this retention device is used for retention, an accelerated air stream that has a suction effect cannot form in the Venturi nozzle. Consequently, a reversal of direction takes place, and the air, which continues to accumulate, will get into the suction chamber through the Venturi nozzle. This air forced into the suction chamber can then be used for filling the inflatable textile bag.

If the retention device is removed or is selected to no longer function for retention, nothing further stands in the way of formation of an air stream that rapidly flows through the Venturi nozzle, as intended, and also provides a partial vacuum by way of the Venturi effect, so that the air can be drawn in out of the suction chamber and therefore also out of the inflatable textile bag.

Preferably, the optionally retaining retention device is disposed behind the Venturi nozzle, since this allows the corresponding effect to be implemented in structurally particularly simple manner.

Cumulatively or alternatively, an opening into the suction chamber that can be optionally opened and closed can be provided between the air inlet and the air outlet. By way of this opening, the suction chamber can be optionally supplied with air, in targeted manner, so as to provide an excess of air in this way, which can then be used for filling the inflatable textile bag.

If the opening is closed, this excess of air is eliminated, so that the suction chamber can be emptied again in a targeted manner, into and through the Venturi nozzle, in pressure-reducing manner.

The openable and closable opening can, in particular, be provided between the Venturi nozzle and the air outlet, and this also applies to the optionally retaining retention device.

In a particularly preferred embodiment, the openable and closable opening and the retaining retention device are formed by a common module, for example by a flap or other three-way valve, which is disposed in such a manner that in one position, the air stream flowing through the Venturi nozzle can pass through without being influenced, to the greatest possible extent, and, at the same time, can close the openable and closable opening, which accordingly corresponds to the suctioning or emptying state, while in a different position, the air stream flowing through the Venturi nozzle is retained, and the openable and closable opening is opened, so that the air stream that flows through the Venturi nozzle can get through the Venturi nozzle itself, on the one hand, and through the opening into the suction chamber, on the other hand.

A filter arrangement can be provided between the air inlet and the Venturi nozzle in order to prevent foreign material or dirt material from penetrating into the Venturi nozzle and, in particular, into the inflatable textile bag, in this manner. In this regard, the filter arrangement can have filter screens or the like, for example. A labyrinth arrangement is likewise particularly advantageous, because it is easy to keep it unblocked. The filter arrangement preferably has a dirt deflector, which diverts collected foreign material or dirt and, in particular, also water from the filter to the outside. This can be implemented, for example, by small openings in the filter region.

Furthermore, the filter arrangement advantageously serves for reduction of possible pressure fluctuations.

Dirt particles can be removed from the air stream relatively effectively by means of filters formed by deflecting plates, due to the relatively large changes in speed in the region of the deflection plates, without impairing the air stream too much in terms of its volume flow.

A check valve can also serve for reducing pressure fluctuation; this is provided between the air inlet and the Venturi nozzle. Depending on the concrete embodiment, this check valve can be spring-loaded or disposed in the vicinity of the air inlet solely in weight-loaded manner.

The check valve can also prevent penetration of larger objects or larger quantities of water or the like, in particular when the vehicle is standing still.

A conical air inlet appears to be advantageous for reducing turbulences and maximizing retention pressure.

Means for regulating the opening cross-section of the air inlet can be provided on the air inlet. Thus, for example, when the maximal loading pressure of the inflatable textile bag has been reached, the air inlet can be partially closed in order to lower the air resistance. For this purpose, it is particularly advantageous if the regulating means engage into the air inlet from the bottom to the top, and conduct part of the air flow away by way of the air inlet or, alternatively, conduct part of the air flow past the air inlet laterally, so that a possible air backup in front of the closed air inlet or the partially closed air inlet can be reduced to a minimum.

A possible Venturi nozzle is any suitable nozzle arrangement in which the Venturi effect is used. An acceleration chamber having a perforated wall to the suction chamber has proven to be a particularly preferred embodiment, since it permits good flow guidance even over long distances, so that sufficiently large air masses can be transported into the suction chamber and also out of it, in operationally reliable and rapid manner.

If a drive for the inflatable textile bag, by means of which the bag can be displaced in some way, for example in order to uncover a rear side of the vehicle, has a drive carriage, this carriage can preferably carry the venting device or the filling and/or venting device. In this manner, the venting device or the filling and/or venting device remains in its local position with regard to the inflatable textile bag when the bag is displaced, and this helps to avoid the use of movable connections between the inflatable textile bag and its venting device or filling and/or venting device, despite a displacement.

It is understood that if applicable, the filling and/or venting device can also be provided at a different location, for example on a cabin roof, if the corresponding air pressure is then conducted to the inflatable textile bag by way of a hose or by way of a similar system.

The inflatable textile bag can have a heater, so that the risk of icing can be minimized, in particular in winter.

Preferably, the heater is provided in the venting device or filling and/or venting device, since icing processes or even undesirable condensate can most likely be expected at this location, and since any air which is heated there can also be used to heat the remainder of the inflatable textile bag. In particular, the heater can be provided, for example, in or on modules that are present in any case, such as, for example, on filter plates or on the wall of the Venturi nozzle.

Preferably, the inflatable textile bag is configured to be indivisible, although this does have the disadvantage that it must then also be removed, in its entirety, from the rear side when the latter must be exposed. On the other hand, this allows excellent stability of the inflatable textile bag, which applies, in particular, if the rear wall of the inflatable textile bag is configured to be indivisible. In this manner, the rear wall can act in stabilizing manner, to a sufficient extent, by way of the stabilizer described above or the stabilizer surface elements, and, in particular by way of a possible central element as a stabilizer surface element.

On the other hand, a divided inflatable textile bag can also prove to be advantageous, because then a part of the inflatable textile bag can be firmly connected with the respective door panel on each door of a two-panel door, for example. However, the divided inflatable textile bag requires that then, if necessary, a sufficiently airtight connection between the two parts must be created, and ultimately this would lead to a significant expenditure for very delicate or complex activities during normal loading activities. Also, with regard to a possible stabilizer, connection lines would possibly have to be opened and closed, and this would lead to a corresponding expenditure. Under some circumstances, however, a central element could be configured, for example, in duplicate, and an openable and closable connection element could then be disposed between the two central elements. Such a connection element can then be disposed, in particular, at the connection between the two central elements and the rear wall and the outer wall or walls of the inflatable textile bag and thus define the division. It is understood that corresponding divisions can also be provided correspondingly at other locations, wherein it is then advantageous to configure sufficiently air-permeable surfaces of stabilizer surface elements that are in contact with one another, for example also by means of holes, in order to have as little a negative influence on the force distribution as possible. The connection elements are preferably configured to be sufficiently sealing so that possible leakage streams do not become overly large.

As an alternative to this, two independent inflatable textile bags, in particular, in each case, with their own stabilizer, can be provided on each of the door panels, which inflatable bags have their own rear wall and their own outer wall, in each instance, which walls seal the interior of the respective inflatable textile bag toward the outside, so that the entire outer wall and also the rear wall have the internal pressure applied to them on the inside, and atmospheric pressure applied to them on the outside, if necessary reduced by a speed-related component, and within which walls, in particular, a stabilizer can also be provided. In this regard, the outer walls can face and possibly contact each other on the respective side that faces the other of the two inflatable textile bags.

The above connection elements can also be suitable, in particular, for the purpose of quickly emptying the inflatable textile bag, in particular if other venting devices do not function, for example in the event of an accident or in the event of sudden stopping of the vehicle. For this purpose, the connection element merely needs to be opened.

In this regard, independent of all the other characteristics of the present invention, a quick-action vent that comprises an openable and closable quick-action venting opening in a wall of the inflatable textile bag, is correspondingly advantageous for an inflatable textile bag for lowering the drag of vehicles, having a vehicle side and a rear side, wherein a holding apparatus for fastening the inflatable textile bag to a vehicle is disposed on the vehicle side, and the inflatable textile bag has a filled state and an emptied state.

Preferably, the openable and closable quick-action vent opening or openings or the openable and closeable connection element or elements are disposed within reach of operating personnel or so as to be reachable from the ground, so that manual access is possible in correspondingly simple manner.

The openable and closable quick-action vent opening or openings or the openable and closeable connection element or elements can, in particular, be provided on a connection line between surface elements, such as, for example, between stabilizer surface elements and/or inflatable bag surface elements among one another. In this manner, the integrity of the inflatable textile bag is only insignificantly impaired, and no separate openings or further measures need to be provided.

The openable and closable quick-action vent opening or openings or the openable and closeable connection element or elements can be implemented, in particular, by means of a two-component closure system, which systems can often also easily be configured to be sufficiently airtight. Thus, for example, zippers or planar hook-and-loop closures, also referred to as Klett® or Velcro® closures, are a possibility in this regard in this regard.

It is understood that the characteristics of the solutions described above or in the claims can also be combined, if applicable in order to be able to implement the advantages in correspondingly cumulative manner.

Further advantages, aims and characteristics of the present invention will be explained using the following description of exemplary embodiments, which are also shown, in particular, in the accompanying drawing. The drawing shows:

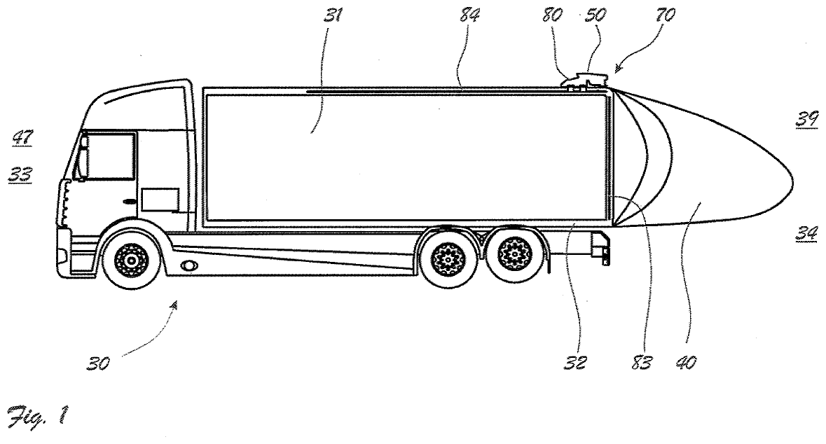

FIG. 1 in a schematic side view, a vehicle with an inflatable textile bag fastened to it by way of a holding apparatus;

FIG. 2 the inflatable textile bag according to FIG. 1 in a perspective elevation line representation from the rear side, at an upward slant;

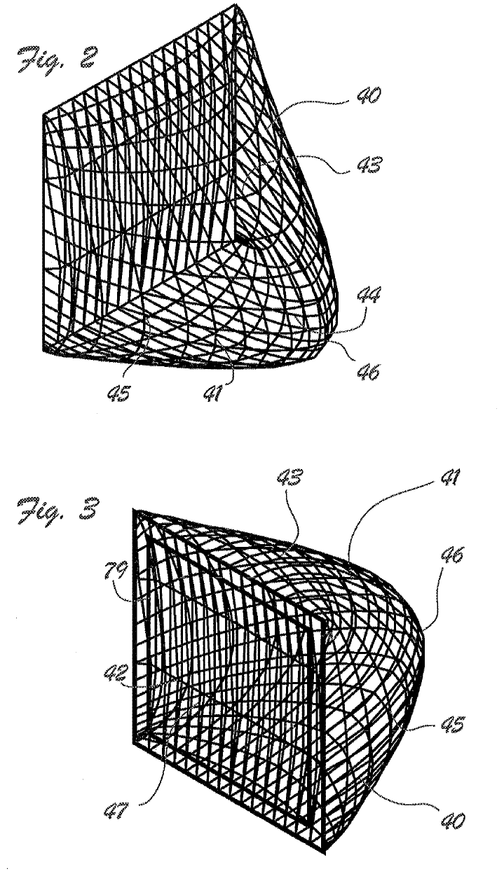

FIG. 3 the inflatable textile bag according to FIGS. 1 and 2 in a perspective elevation line representation from the vehicle side, at an upward slant;

FIG. 4 a cutting pattern for the inflatable textile bag according to FIGS. 1 to 3;

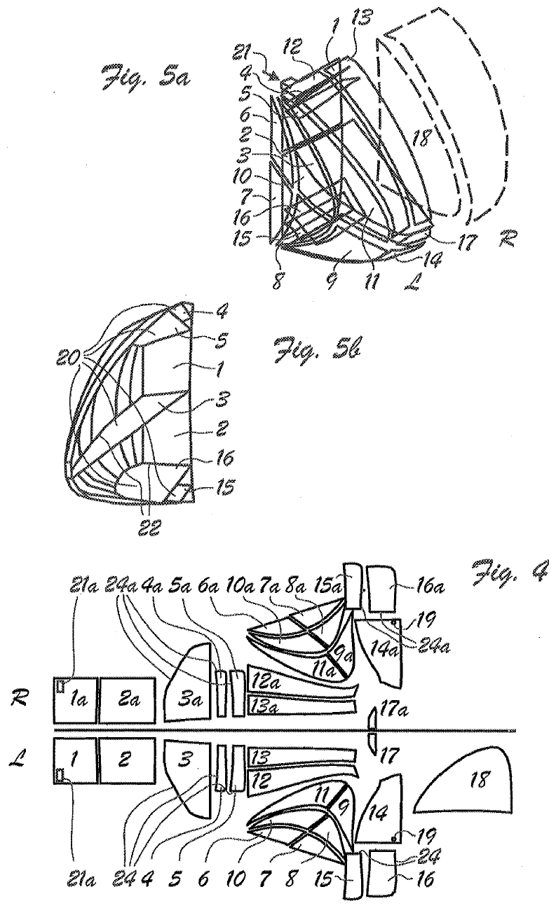

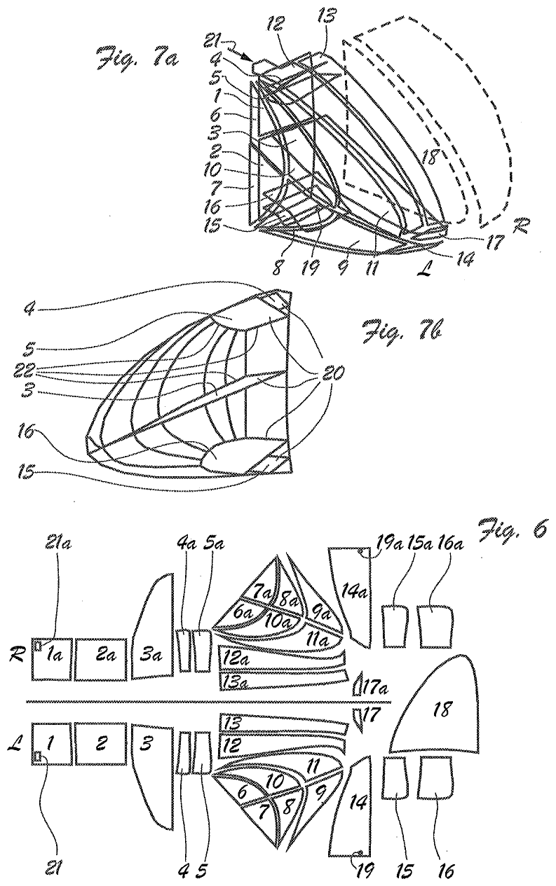

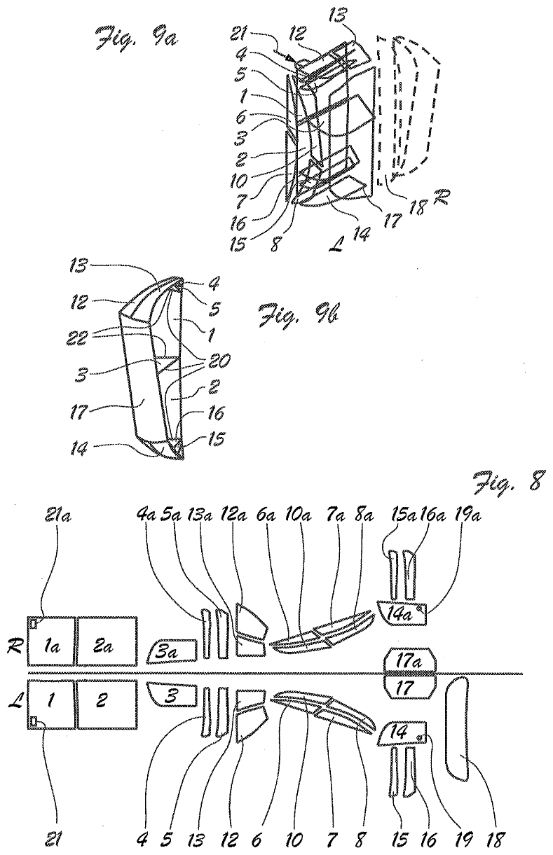

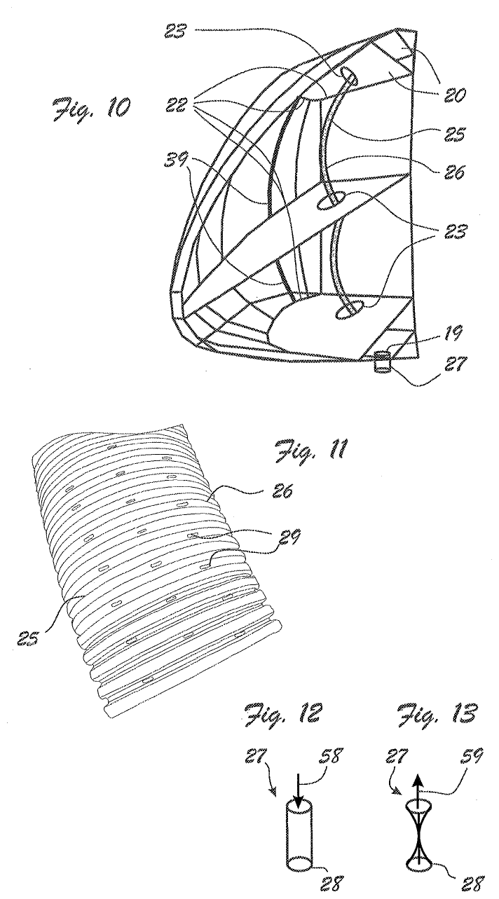

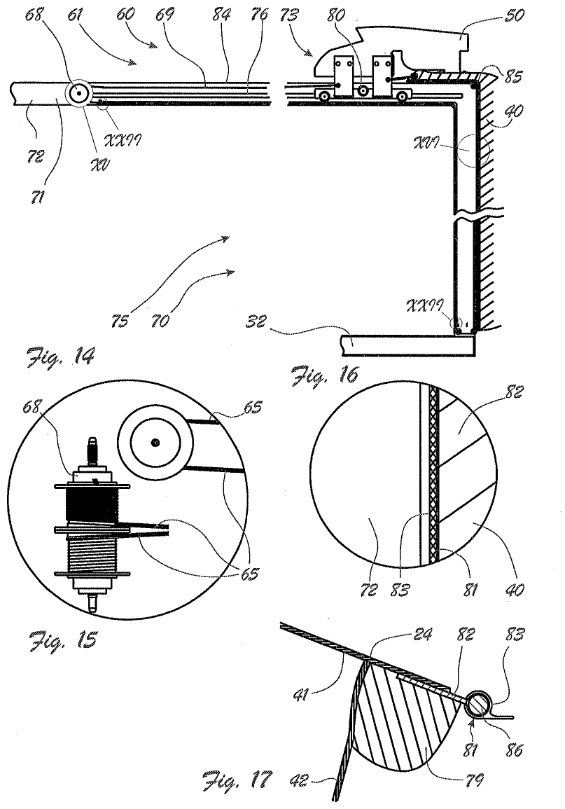

FIG. 5a the left side and, with broken lines, the right side of the inflatable textile bag according to FIGS. 1 to 4 in an exploded view from a perspective similar to FIG. 2;

FIG. 5b the left side of the inflatable textile bag according to FIGS. 1 to 4 from the inside;

FIG. 6 a cutting pattern for a further inflatable textile bag;

FIG. 7a the inflatable textile bag according to FIG. 6 in a representation similar to FIG. 5a;

FIG. 7b the inflatable textile bag according to FIG. 6 in a representation similar to FIG. 5b;

FIG. 8 a cutting pattern for a further inflatable textile bag;

FIG. 9a the inflatable textile bag according to FIG. 8 in a representation similar to FIGS. 5a and 7a;

FIG. 9b the inflatable textile bag according to FIG. 8 in a representation similar to FIGS. 5b and 7b;

FIG. 10 an inflatable textile bag similar to the inflatable textile bag shown in FIGS. 1 to 6, with an air channel and holes and with an outlet valve, in a representation similar to FIG. 6;

FIG. 11 a perspective detail view of the air channel according to FIG. 10;

FIG. 12 the outlet valve according to FIG. 10 in the open state;

FIG. 13 the outlet valve according to FIG. 10 in the closed state;

FIG. 14 the holding apparatus according to FIG. 1 in a schematic and broken side view;

FIG. 15 a detail enlargement XV of a bidirectional winding drum from FIG. 14, and a schematic top view of the same;

FIG. 16 a detail enlargement XVI of a keder guide from FIG. 14;

FIG. 17 a section through FIG. 16;

FIG. 18 a holding apparatus as an alternative to the holding apparatus shown in FIGS. 1 and 14, in a representation similar to FIG. 14;

FIG. 19 a detail enlargement XIX of a sliding block guide from FIG. 18;

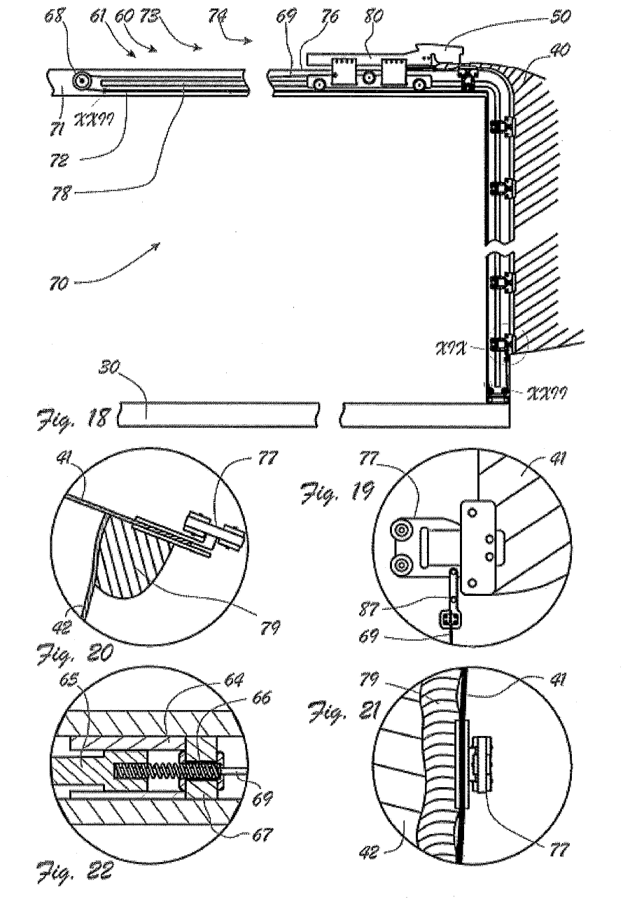

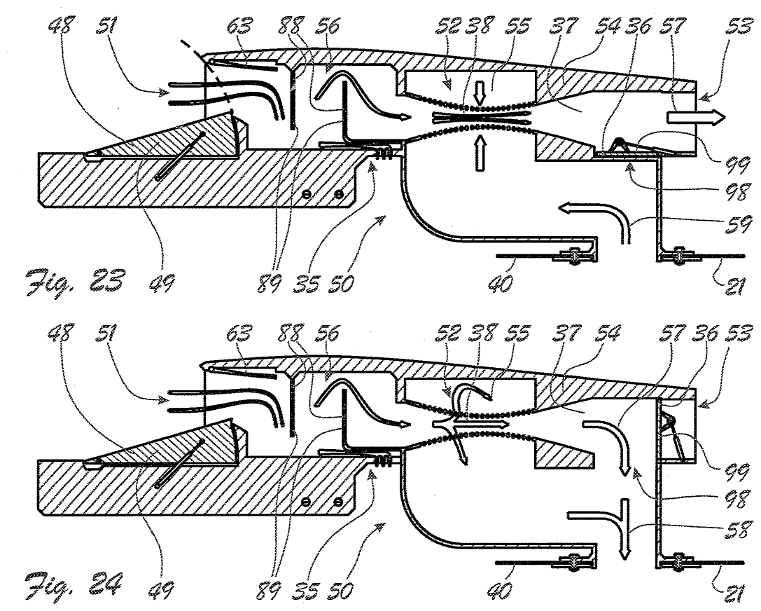

FIG. 20 the arrangement according to FIG. 19 in section;

FIG. 21 a view from the vehicle side to the rear side of the arrangement according to FIGS. 19 and 20;

FIG. 22 a detail enlargement XXII of a self-tensioning Bowden cable arrangement according to FIGS. 14 and 18;

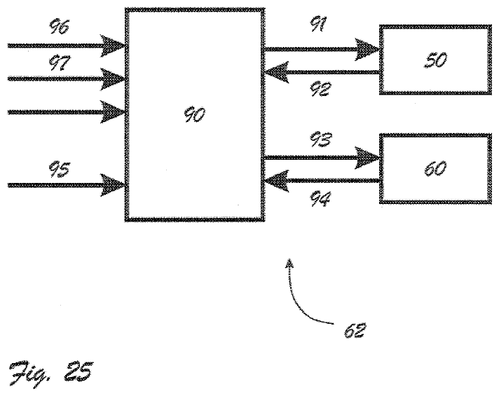

FIG. 23 a schematic sectional view of a filling and/or venting device in the suction-application state;

FIG. 24 the arrangement according to FIG. 23 in the pressure-building state;

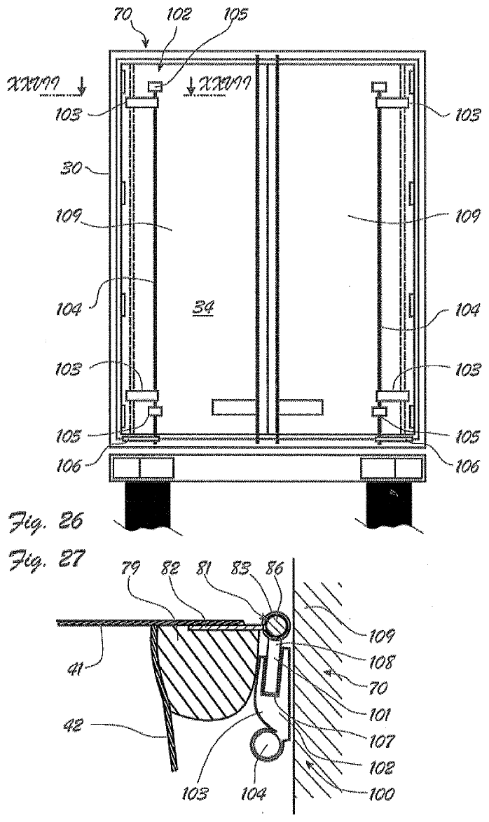

FIG. 25 a schematic illustration of a controller for an inflatable textile bag and its holding apparatus;

FIG. 26 a component of a two-component holder and a tensioning device at the rear of a vehicle;

FIG. 27 a section through an inflatable textile bag held by the holder and tensioned by the tensioning device, along the line XXVII-XXVII in FIG. 26.

The vehicle 30, which is configured as a commercial vehicle and is shown in FIG. 1, carries a box body 31 and has a frame structure 32, to which an inflatable textile bag 40 is attached, which, in a filled state, can lower the drag of the vehicle 30 in known manner when the vehicle is moving in the direction of its front side 33.

The vehicle 30 furthermore has a rear side 34, on which the inflatable textile bag 40 is provided, which accordingly has a vehicle side 47 facing the vehicle 30, which corresponds, in terms of its orientation, to the front side 33 of the vehicle 30, and a rear side 46, which corresponds, in terms of its orientation, to the rear side 34 of the vehicle 30.

As illustrated, in particular, in FIGS. 2 and 3, the inflatable textile bag 40 has an outer wall 41 and a rear wall 42, wherein the rear wall 42 can be found essentially on the vehicle side 47 of the inflatable textile bag 40, while the outer wall 41 faces in the direction of the rear side 46.

The inflatable textile bag 40 can furthermore be associated with a top side 43 and an underside 44, which are aligned in accordance with the top side and the underside of the vehicle 30; this does not require further explanations. The same holds true for two horizontal sides 45, which are aligned in accordance with the horizontal sides of the vehicle.

In this regard, FIGS. 2 and 3 likewise show the inflatable textile bag 40 in the filled state, in which the rear wall is curved in the direction of the rear side 46, as represented by contour lines in FIGS. 2 and 3. This curvature corresponds, in terms of its height, to approximately 7% of the longitudinal expanse of the inflatable textile bag 40 from the rear side 46 to the vehicle side 47, wherein other dimensions are also conceivable here, depending on the concrete implementation.

Furthermore, an outer ring 79 is provided on the rear wall 42, which ring surrounds the curvature and stabilizes the edge of the inflatable textile bag 40 on its vehicle side 47.

The inflatable textile bag 40 is composed of inflatable bag surface elements 1, 2 for the rear wall 42, and of inflatable bag surface elements 6, 7, 8, 9, 10, 11, 12, 13, 14, and 17 for the outer wall 41, wherein the inflatable bag surface elements 6, 7, 8, 9, 10, and 11 serve to form a side wall, the predominant direction component of which is oriented parallel to the horizontal side 45. A top wall having a predominant alignment toward the top side 43 is formed by the inflatable bag surface elements 12 and 13, and a bottom wall, which is oriented essentially parallel to the underside 44, is formed by the inflatable bag surface element 14. In the present exemplary embodiments, the inflatable bag surface element 17 represents the rear side.

The corresponding approaches can be found, in particular, in FIGS. 4 and 5, as well as in 6 and 7, wherein a somewhat shorter inflatable textile bag 40 is provided in FIGS. 8 and 9, in which individual inflatable bag surface elements have been dispensed with and, in particular, the inflatable bag surface element 17 for the rear side 46 is configured to be significantly larger.

As is directly evident, the inflatable bag surface elements 6, 7, 8, 9, 10, 11, 12, 13, 14, and 17 are each formed from textile material, which is selected to be essentially air-impermeable. Furthermore, the inflatable bag surface elements 6, 7, 8, 9, 10, 11, 12, 13, 14, and 17 are connected with one another by way of seams.

Alternatively, instead of seams, of course, other types of connection, such as adhesive lines or weld lines, for example, can be used accordingly.

As is directly evident from FIGS. 4 to 9, the inflatable textile bag 40 has a symmetrical structure, wherein in FIGS. 5a and 5b, 7a and 7b, or 9a and 9b, in each instance, essentially only the left side (L) is shown. The right side (R) is only shown in the cutting patterns of FIGS. 4, 6, and 8, and is merely shown with a broken line in FIGS. 5a, 7a, and 9a.

A stabilizer 20 is disposed within the inflatable textile bag 40 and consists of stabilizer surface elements 3, 4, 5, 15, 16, and 18, wherein the stabilizer surface element 18 serves as a central element and divides the right side of the inflatable textile bag 40 from the left side. The central element 18 reaches from the rear wall 42 all the way to the inflatable bag surface element 17 for the rear side 46, and is otherwise connected both with the top wall and the bottom wall. If, in an alternative embodiment, two jointly active inflatable textile bags 40 are to be disposed on the vehicle 30, it would be conceivable, for example, to put on two similarly cut inflatable bag surface elements instead of the central element 18, which are then connected with the divided rear wall 42 and with the remainder of the outer wall 41 of the respective inflatable textile bag 40, in each instance, so as to become an integral part of the outer wall 41 of the respective inflatable textile bag 40. Even then, one stabilizer 20 formed by the stabilizer surface elements 3, 4, 5, 15, and 16 remains within each of the two inflatable textile bags 40, in each instance, wherein it is understood that if necessary, a supplemental central element 18 can then still be inserted into each of the inflatable textile bags 40.

The stabilizer surface elements 3, 4, 5, 15, and 16 are also each connected with the rear wall 42, in each instance and connected with the outer wall 41 of the inflatable textile bag 40 on at least two edges. They meet at the central element 18 with their counterparts of the partial inflatable bags that lie on the other side, in each instance, so that in particular, symmetrical forces also act on the central element 18, and this element can also act in particularly stabilizing manner.

The cutouts of the surface elements as a whole are selected in such a manner that in the filled state, the rear wall 42 has a curvature, in operationally reliable manner, as has already been explained above.

The stabilizer surface elements 3, 4, 5, 15, 16, and 18 are connected with one another or with the outer wall 41 and the rear wall 42 of the inflatable textile bag 40 by way of seams, in each instance. In different embodiments, adhesive connections or welded connections or similar types of connection can also be used here.

In this regard, the stabilizer surface elements 3, 4, 5, 15, 16, and 18 are aligned in such a way that they are essentially only subject to tensile stress, wherein with the exception of the central element 18, all the stabilizer surface elements 3, 4, 5, 15, and 16 are connected with other stabilizer surface elements 18 or the outer wall 41 or the rear wall 42 only at their edges 24.

In this manner, the stabilizer surface elements 3, 4, 5, 15, and 16 can act on the outer wall 41 and the rear wall 42 in particularly stable manner, in terms of their surface. This also holds true for the central element 18, since this is subject to stress by way of the other stabilizer surface elements 3, 4, 5, 15, and 16, in terms of its surface, and subject to a load symmetrically and uniformly from both sides, in each instance.

In this regard, connection of the stabilizer surface elements 3, 4, 5, 15, and 16 takes place only at their edges 24, by way of connection lines 22, wherein only the stabilizer surface elements 3 and 18 have common connection lines 22 with connection lines between inflatable bag surface elements 1, 2, 6, 7, 8, 9, 10, 11, 12, 13, 14, and 17, while the remaining stabilizer surface elements 4, 5, 15, and 16 intersect the connection lines of the inflatable bag surface elements and, in this way, have a particularly stabilizing effect.

The inflatable bag surface element 14, which forms the bottom wall, has an opening 19 at its lowest point, in each instance, which opening is used for an outlet valve 27, as is shown as an example in FIGS. 10, 12, and 13.

In this regard, the outlet valve 27 is represented by an implodable hose 28, which is open at pressure 58, so that any dirt, condensate, penetrated water or other foreign bodies can drop out of the inflatable textile bag 40. If the inflatable textile bag 40 is vented and a suction 59 is produced, the hose 28 will implode and the outlet valve 27 will close autonomously. In this regard, no separate control is necessary, and therefore the outlet valve 27 can be referred to as being passive.

The inflatable textile bag 40 can also have an air channel 25, as illustrated in FIGS. 10 and 11, which can be represented by an air hose 26 having openings 29. By means of such an air hose 26 or air channel 25, it can be ensured, in operationally reliable manner, that air passes into or from any chambers which are caused by the stabilizer 20 within the inflatable textile bag 40.

In this regard, it is conceivable that the air channel 25 is freely suspended within the inflatable textile bag 40. Alternatively, however, the channel can be connected, in targeted manner, for example, with an air inlet 21, which is provided in the inflatable textile bag 40, and by means of which the bag can be filled and/or vented.

Likewise, holes 23 can be provided in the stabilizer surface elements 3, 4, 5, 15, 16, 18, which holes, as is shown as an example using the stabilizer surface elements 16, 3, and 5 in FIG. 10, can ensure air passage between the chambers mentioned above.

Depending on the concrete embodiment, the air channel 25 or the air hose 26 can be disposed in such holes 23. The air channel 25 can likewise be worked into the stabilizer surface elements 3, 4, 5, 15, 16, 18, in sealed manner, so that it is then no longer possible to speak of holes 23 in the sense of ventilation made possible directly by them when speaking of the openings in the stabilizer surface elements 3, 4, 5, 15, 16, 18 which are then necessary.

It is understood that a plurality of holes 23 can also be provided in different embodiments, as long as a corresponding inherent stability of the stabilizer surface elements 3, 4, 5, 15, 16, 18 is not impaired.

In the connection between the inflatable bag surface elements 6 and 10 or 7 and 8, zippers 39 are provided in the exemplary embodiment shown in FIG. 10, which zippers serve as a quick-action vent and release a quick-action vent opening when they are opened. In this way, for example in the event of an accident, rapid emptying of the inflatable textile bag (40) can be made possible. In this regard, the zipper 39 between the surface elements 7 and 8 is easily accessible even from below, while the upper zipper 39 between the inflatable bag surface elements 6 and 10 is then also easily accessible when the underside of the inflatable bag is emptied, to a great extent.

Furthermore, the corresponding air channel 25, the holes 23 and the outlet valve 27 can also be used to advantage in the inflatable textile bag 40 illustrated in FIGS. 1 to 9, as well as in other inflatable textile bags.

The inflatable textile bag 40 is fastened onto the vehicle 30 by means of a holding apparatus 70, which has a carrier 71 as a fixed holding device 72, which carrier or device is firmly connected to the frame construction 32 of the commercial vehicle 30. It is understood that in different embodiments, the carrier 21 can also be provided in the frame structure of the vehicle 30 itself.

So as to expose the rear side 34 of the vehicle 30 as required, the inflatable textile bag 40 is fastened to the holding device 72 via a sliding guide 73.

In the exemplary embodiment shown in detail in FIGS. 14 to 17, the sliding guide 73 is configured as a keder guide 75 and comprises a separate guide rail 76 for a drive carriage 80, by way of which the inflatable textile bag 40 is moved in the keder guide. In addition to the guide rail 76, the carrier 71 also carries a first keder rail 83 and a second keder rail 84, as well as a curved keder rail 85, which guarantees a uniform transition between the first and the second keder rail 83, 84, wherein for this purpose the keder guide 75 is inclined in the direction of curvature in the region of the curved keder rail, as is illustrated as an example in FIG. 17. In this regard, the small flag pointing away from the first keder rail 83 is oriented parallel to the direction of travel of the vehicle 30, and thereby the angle can be recognized on the basis of the alignment of the associated keder flap 82 of the keder 81.

In this exemplary embodiment, the slanted orientation of the keder rail is found throughout, both in the curved keder rail 85 and in the first and second keder rail 83, 84; this is simple in terms of design and, when the inflatable textile bag 40 is under tension, leads only to insignificant turbulences or tensions.

As is evident, in particular, from FIG. 17, the outer ring 79 is worked into the rear wall 42, and, together with the outer wall 41, surrounds the keder flap 82, which in turn reaches into the keder rail 83, 84, 85, and surrounds a keder bead 86, by means of which operationally reliable stay of the keder flap 82 in the keder guide 75 is guaranteed.

A drive 61 having a controller 62 (see FIG. 25) is used as the positioning system 60, wherein the drive has a bidirectional winding drum 68, on which two cables 69 are wound up bidirectionally, wherein one of the cables 69 acts on the drive carriage 80 in pulling manner, while the other of the two cables 69 is connected with the keder bead 86 from the side of the inflatable textile bag that faces away from the drive carriage. Furthermore, the drive carriage 80 is likewise connected with the keder bead 86, so that in this manner, a closed or circumferential cable is produced and the inflatable textile bag 40 can be displaced, by way of the drive 61, in both directions of the keder rails 83, 84, 85, along the sliding guide 73 formed in this way.

In the sliding guide 73 shown in FIGS. 18 to 21, a sliding block guide 74 is used instead of a keder guide 75, in which the inflatable textile bag is connected with multiple sliding guide carriages 77, as illustrated in detail, as an example, in FIGS. 19 to 21. Furthermore, in this arrangement, the carrier 71 of the holding apparatus 70 serves directly as a guide rail for the drive carriage 80, wherein the carrier 71 furthermore also has a guide rail 78 for the sliding block carriages 77, so that the latter can be displaced along the carrier 71 and therefore along the sliding guide 73.

The drive 81 of the associated positioning system 60 essentially corresponds to the drive 61 or the positioning system 60 of the exemplary embodiment according to FIG. 14, so that repetitions are dispensed with in this regard.

Fastening of the sliding block carriages 77 to the inflatable textile bag 40 is also structured in relatively similar manner, wherein here, clips engage around the outer wall 41, and the outer ring 79 worked into the rear wall 42 in turn encloses one of the clamping jaws jointly together with the outer wall 41, and this accordingly guarantees a very stable connection.

Both in the exemplary embodiment according to FIG. 14 and in the exemplary embodiment according to FIG. 15, a self-tensioning Bowden cable, which comprises a steel core 65 with a Bowden cable sheath 64, is provided in the circumferential overall cable, which, in particular, comprises the cables 69; it is configured to be self-tensioning in known, manner, by way of a Bowden cable tensioning spring 66, by means of a guide cylinder on the winding drum side, i.e. a reciprocal guide cylinder 67. In this manner, the entire cable can be provided with a uniform tensile force.

In the exemplary embodiment according to FIG. 18, the cables 69 are fastened to the sliding block carriage 77 or to the outer sliding block carriage 77 by way of a cable fastener 87.

For filling and venting, the exemplary embodiments presented here have a filling and/or venting device 50, which is shown in detail in FIGS. 23 and 24 and comprises an air inlet 51, a Venturi nozzle 52, and an air outlet 53.

In this exemplary embodiment, the air inlet 51, the Venturi nozzle 52, and the air outlet 53 are configured in a nozzle body 54, which is provided on the drive carriage 80, so that the filling and/or venting device 15 remains in a defined position with regard to the inflatable textile bag 40 and can be firmly connected with the bag at its air inlet 41.

In alternative embodiments, the filling and/or venting device 50 can be provided at a different position on the vehicle 30, so as to then guide air to the inflatable textile bag 40 by way of a hose or to empty it by suction, for example. Then a single filling and/or venting device 50 can also be sufficient, for filling and/or venting the left side and the right side of the inflatable textile bag 40.

The Venturi nozzle 52 has an acceleration chamber 38 and an expansion chamber 37, in known manner, wherein the expansion chamber 37 also serves, in particular, for slowing down the air stream 57 when it leaves the filling and/or venting device 50 through the air outlet 53, so that the air resistance of the vehicle 30 is not unnecessarily increased.

In addition, the Venturi nozzle 52 has a suction chamber 55, which, in the case of this exemplary embodiment, is connected with the acceleration chamber 38 by way of a perforated wall and thereby guarantees good flow guidance of the air stream 57 through the Venturi nozzle 52 over a particularly long distance. It is understood that other embodiments of Venturi nozzles are also conceivable here in different embodiments.

A retention device 99 is provided in the vicinity of the air outlet 53, which device is implemented by way of a control flap 36. The control flap 36 can block the air outlet 53, at least in part, and thereby backup of the air by the Venturi nozzle 52 takes place, and this leads to the result that the air from the expansion chamber 37 gets into the suction chamber 55, so as to put the inflatable textile bag 40 under pressure 58 in this manner. An opening 98 is also provided behind the Venturi nozzle 52, which opening connects the air stream 57 or the expansion chamber 37 with the intake chamber 55, so that air can also be made available to the inflatable textile bag 40 as pressure 58 in this manner.

In this regard, in this exemplary embodiment, the opening 98 can likewise be opened and closed by the control flap 36, but this can also be implemented differently in different exemplary embodiments.

Because the control flap 36 both opens the opening 98 and also because the control flap 36 makes the retention device 99 act with a retention effect by closing or reducing the size of the air outlet 53, pressure 58 for the inflatable textile bag 40 can be made available in particularly effective manner. The same also holds true for suction 49, in that the control flap 36 closes the opening 98 and releases the air outlet 53, so that the Venturi effect can become active directly.

A filter arrangement 56 is provided downstream from the air inlet 51 and upstream from the Venturi nozzle 52, which arrangement is implemented by means of deflection plates 88 in this exemplary embodiment. In this regard, the sharp directional reversals at the deflection plates 88 are used for elimination of dirt particles, water or similar foreign bodies, wherein these are then guided through a dirt deflector 35 by way of a small fault air stream; in this exemplary embodiment, this deflector is represented solely by holes.

It is understood that in other exemplary embodiments, different filter arrangements can also be used instead of the filter arrangement 56, such as, for example, net-like filters or cyclone filters, wherein the filter arrangement 56 has proven to be structurally simple and also to be very reliable under different weather conditions.

Each of the filter arrangements furthermore acts to slow down the flow, and this is also guaranteed, in particular, by means of a check valve 63, which is provided on the air inlet 51. In the present exemplary embodiment, the check valve 63 is merely weight-loaded. In different embodiments, it can also be spring-loaded.

The check valve furthermore guarantees that as few foreign bodies as possible pass through the air inlet 51 when the vehicle is at a standstill.

In the present exemplary embodiment, the deflection plates 88 are provided with a heater 89, by means of which both the nozzle body 54 and the air stream 57 can be heated. This serves for avoiding possible icing and for minimizing possible condensation effects. It is understood that other types of heaters can also be provided in different embodiments. In particular, a heater can also be present at a different location. Heating of the air stream 57 and, in particular, of the air entering the inflatable textile bag 40 also has the advantage, in particular, that icing and condensates can be minimized in the inflatable textile bag 40.

Furthermore, regulating means 59, by means of which the opening cross-section of the air inlet 51 can be changed, are provided on the air inlet 51.

In the present exemplary embodiment, the regulating means 49 comprise an inflow flap 48, and this represents particularly simple structural implementation of the regulating means 49.

Furthermore, the inflow flap 48 is beveled, so that a conical air inlet 51 can be guaranteed, thereby making it possible to furthermore reduce turbulences and to maximize the dynamic pressure.

If the inflow flap 48 is raised in order to reduce the air flow 57 passing through the filling and/or venting device 50 and, in particular, also to reduce the air stream getting into the inflatable textile bag 40, the conical configuration of the inflow flap 48 makes it possible for part of the air stream to be guided past the air inlet 51, so that unnecessary reduction of the air resistance of the overall arrangement can be avoided.

It is understood that the afore mentioned holding device 72, the drive 61, and the drive carriage 80 as well as the filling and/or venting device 50 are correspondingly provided on each vehicle side of the vehicle 30, i.e. in relation to both the right and the left part of the inflatable textile bag, but this does not necessarily have to be the case in other embodiments.

The control unit 90, which has already been briefly explained above, is preferably configured as a microcontroller, although conventional electric circuits can also be used here. In this regard, the control unit 90 communicates with the filling and/or venting device 50, in order to fill or empty the inflatable textile bag 40 (91). The filling and/or venting device 50, on the other hand, reports its status regarding whether the inflatable textile bag 40 is filled or emptied (92).

With reference to the positioning system 60, the control unit 90 communicates with the positioning system 60 and commands it to move out or in (93). The positioning system 60 reports its status as being moved out or in (94).

The control unit 90 furthermore takes into account the speed 96 of the vehicle 30 and the air pressure 97 in the inflatable textile bag 40, with regard to its communication with the filling and/or venting device 50 and the positioning system 60, in order to be able to intervene accordingly, depending on the requirements.

Furthermore, manual moving in or out 95 is provided as a command input for the control unit 90.

Further control possibilities can also be provided in the control unit 90. It is likewise conceivable to connect supplemental controllers ahead of or after the control unit 90.

As shown in FIGS. 26 and 27, the inflatable textile bag 40 can be fastened to and removed from the rear 34 of the vehicle 30 by way of the keder rails 83, in quick and simple manner, if the rails carry a first component 101 of a tensioning and holding device 100 of the holding apparatus 70.

The second component 102 of the tensioning and holding device 100 can then be fastened to the rear 34 of the vehicle 30 and, in particular, to its doors 109.

In the present exemplary embodiment, the first component 101 comprises a groove 107 on the keder rail 83, while the second component 102 comprises an associated tongue 108, which is provided on a tensioning and holding lever 103. Multiple tensioning and holding levers 103 are seated on a tensioning shaft 104, which is rotatably fastened to the door 109 by means of fastenings 105, and carries an actuating lever 106 in the vicinity of the underside of the vehicle 30.

Corresponding arrangements are located mirror-symmetrically on both doors 109, so that the keder rails 83, in which the inflatable textile bag 40 is held by way of the keders 81, is merely laid into the groove 107, and the position of the actuating lever 106 has to be changed in such a manner that the tensioning and holding lever 103 makes contact with the door. On the basis of the overall geometry, this then leads to tensioning of the inflatable textile bag.

It is understood that, if applicable, the tensioning lever can also be provided on the inflatable textile bag 40 or, on the inflatable textile bag side, on the two-component tensioning and holding device 100. Then one component of the two-component tensioning and holding device 100, which component is immovably fastened to the vehicle 30, is sufficient.

### LIST OF REFERENCE SYMBOLS

1 inflatable bag surface element for rear wall 42
2 inflatable bag surface element for rear wall 42
3 stabilizer surface element
4 stabilizer surface element
5 stabilizer surface element
6 inflatable bag surface element for side wall
7 inflatable bag surface element for side wall
8 inflatable bag surface element for side wall
9 inflatable bag surface element for side wall
10 inflatable bag surface element for side wall
11 inflatable bag surface element for side wall
12 inflatable bag surface element for top wall
13 inflatable bag surface element for top wall
14 inflatable bag surface element for bottom wall
15 stabilizer surface element
16 stabilizer surface element
17 inflatable bag surface element for rear side 46
18 stabilizer surface element as central element
19 opening in the inflatable bag surface element 14
20 stabilizer
21 air inlet
22 connection line
23 hole
24 edge
25 air channel
26 air hose
27 outlet valve
28 implodable hose
29 openings of the air channel 25
30 vehicle
31 vehicle box body
32 frame construction of the commercial vehicle 30
33 front side of the vehicle 30
34 rear side of the vehicle 30
35 dirt deflector
36 control flap
37 expansion chamber
38 acceleration chamber
39 zipper
40 inflatable textile bag
41 outer wall
42 rear wall
43 top side
44 bottom side
45 horizontal side
46 rear side
47 vehicle side
48 inflow flap
49 regulating means
50 filling and/or venting device
51 air inlet
52 Venturi nozzle
53 air outlet
54 nozzle body
55 intake chamber
56 filter arrangement
57 air stream
58 pressure
59 suction
60 positioning system
61 drive
62 controller
63 check valve
64 Bowden cable sheath
65 steel core
66 Bowden cable tensioning spring
67 guide cylinder on the shaft side/counter-side
68 bidirectional winding drum
69 cable
70 holding apparatus
71 carrier
72 holding device
73 sliding guide
74 sliding block guide
75 keder guide
76 guide rail for drive carriage 80
77 sliding block carriage
78 guide rail for sliding block carriage 77
79 outer ring
80 drive carriage
81 keder
82 keder flap
83 first keder rail
84 second keder rail
85 curved keder rail
86 keder bead
87 cable fastener
88 deflection plate
89 heater
90 control unit/microcontroller
91 inflatable textile bag 40 filling/emptying
92 inflatable textile bag 40 filled/emptied
93 positioning system 60 move out/move in
94 positioning system 60 moved out/moved in
95 manual moving out/moving in
96 speed
97 air pressure in the inflatable textile bag 40
98 opening
99 retention device
R right part of the inflatable textile bag 40
L left part of the inflatable textile bag 40
100 tensioning and holding device
101 first component of the tensioning and holding device 100
102 second component of the tensioning and holding device 100
103 tensioning and holding lever
104 tensioning shaft
105 fastener
106 actuating lever
107 groove
108 tongue
109 door of the vehicle 30

1. Inflatable textile bag (40) for lowering the drag of vehicles (30), having a vehicle side (47) and a rear side (46), wherein a holding apparatus (70) for fastening the inflatable textile bag (40) to a vehicle (30) is disposed on the vehicle side (47), and the inflatable textile bag (40) has a filled state and an emptied state, wherein a stabilizer (20), which keeps its shape but is resilient inward, and comprises at least one stabilizer surface element (3, 4, 5, 15, 16, 18) having a component that extends perpendicular to the surface of the inflatable textile bag (40) is provided in the interior of the inflatable textile bag (40), which element is connected with the inflatable textile bag (40) by way of a connection line (22).

2. Inflatable textile bag (40) according to claim 1, wherein at least one stabilizer surface element (3, 4, 5, 15, 16, 18) has at least one hole (23).

3. Inflatable textile bag (40) according to claim 1, wherein the connection line (22) lies in the interior of the inflatable textile bag (40).

4. Inflatable textile bag (40) according to claim 1, wherein the at least one stabilizer surface element (3, 4, 5, 15, 16, 18) is configured to be textile or movable perpendicular to its surface.

5. Inflatable textile bag (40) according to claim 1, wherein the inflatable textile bag (40) has not only a rear wall (41) but also an outer wall (42) having a top side (43), a bottom side (44), two horizontal sides (45), and the rear side (46).

6. Inflatable textile bag (40) according to claim 5, wherein the at least one stabilizer surface element (3, 4, 5, 15, 16, 18) contacts the rear wall (42) and/or the outer wall (41) of the inflatable textile bag (40) at the connection line (22) and/or with a perpendicular component.

7. Inflatable textile bag (40) according to claim 5, wherein at least one inflatable bag surface element (1, 2), the rear wall (42), and at least one further inflatable bag surface element (6, 7, 8, 9, 10, 11, 12, 13, 14, 17) represent the outer wall (41).

8. Inflatable textile bag (40) according to claim 7, wherein the at least one stabilizer surface element (3, 4, 5, 15, 16, 18) is connected with two of the inflatable bag surface elements (1, 2, 6, 7, 8, 9, 10, 11, 12, 13, 14, 17) that represent the rear wall (42) or the outer wall (41) and/or, if the outer wall (41) is represented by at least two surface elements (6, 7, 8, 9, 10, 11, 12, 13, 14, 17), is connected with these two surface elements (6, 7, 8, 9, 10, 11, 12, 13, 14, 17).

9. Inflatable textile bag (40) according to claim 7, wherein the at least one stabilizer surface element (3, 4, 5, 15, 16, 18) is connected at least with the rear wall (42), as well as with the outer wall (41) on at least two of its edges (24).

10. Inflatable textile bag (40) according to claim 1, wherein the at least one stabilizer surface element (3, 4, 5, 15, 16, 18) is under constant tension in the filled state and, in particular, has no kinks.

11. Inflatable textile bag (40) according to claim 1, wherein the at least one stabilizer surface element (3, 4, 5, 15, 16, 18) is connected with other stabilizer surface elements (3, 4, 5, 15, 16, 18) or with inflatable bag surface elements (1, 2, 6, 8, 9, 10, 11, 12, 13, 14, 17) only at its edges (24).

12. Inflatable textile bag (40) according to claim 1, wherein the at least one stabilizer surface element (3, 4, 5, 15, 16, 18), for example the stabilizer surface element (18) as a central element, divides the interior of the inflatable textile bag (40).

13. Inflatable textile bag (40) for lowering the drag of vehicles (30), having a vehicle side (47) and a rear side (46), wherein a holding apparatus (70) for fastening the inflatable textile bag (40) to a vehicle (30) is disposed on the vehicle side (47), and the inflatable textile bag (40) has a filled state and an emptied state, wherein at least one air channel (25) having openings (29) into the inflatable textile bag (40) is disposed in the interior of the inflatable textile bag (40).

14. Inflatable textile bag (40) according to claim 13, wherein the air channel (25) is configured as a preferably inherently stable and/or perforated air hose (26).

15. Inflatable textile bag (40) for lowering the drag of vehicles (30), having a vehicle side (47) and a rear side (46), wherein a holding apparatus (70) for fastening the inflatable textile bag (40) to a vehicle (30) is disposed on the vehicle side (47), and the inflatable textile bag (40) has a filled state and an emptied state, wherein the inflatable textile bag (40) has a textile rear wall (42) on its vehicle side (47), which wall is curved inward in the filled state and/or comprises a stabilized outer ring (79).

16. Inflatable textile bag (40) according to claim 15, wherein the outer ring (79) is connected with the rear wall (42) and/or with an outer wall (41) in a planar manner, or is worked into the rear wall (42) and/or into an outer wall (41).

17. Inflatable textile bag (40) according to claim 15, wherein the outer ring (79) is configured to be flexible.

18. Inflatable textile bag (40) according claim 15, wherein the depth of the curvature amounts to between half and twice the width of the outer ring (79) and/or greater than 5% of the length of the inflatable textile bag (40) between the vehicle side (47) and the rear side (46) in the filled state.

19. Inflatable textile bag (40) for lowering the drag of vehicles (30), having a vehicle side (47) and a rear side (46), wherein a holding apparatus (70) for fastening the inflatable textile bag (40) to a vehicle (30) is disposed on the vehicle side (47), and the inflatable textile bag (40) has a filled state and an emptied state, wherein an outlet valve (27) is provided on an underside (44) of the inflatable textile bag (40).

20. Inflatable textile bag (40) according to claim 19, wherein the outlet valve (27) is provided at the lowest point of the underside (44) in the filled state.

21. Inflatable textile bag (40) according to claim 19, wherein the outlet valve (27) is configured to be passive.

22. Inflatable textile bag (40) according to claim 19, wherein the outlet valve (27) is formed by an implodable hose (28).

23. Inflatable textile bag (40) for lowering the drag of vehicles (30), having a vehicle side (47) and a rear side (46), wherein a holding apparatus (70) for fastening the inflatable textile bag (40) to a vehicle (30) is disposed on the vehicle side (47), and the inflatable textile bag (40) has a filled state and an emptied state, wherein the holding apparatus (70) comprises two rails, for example keder rails (83), having a first component of a two-component holder, in order to be able to connect the inflatable textile bag (40) with a second component of the two-component holder disposed on a rear side (34) of a vehicle (30), and/or wherein the holding apparatus (70) comprises a tensioning device that acts on the inflatable textile bag (40) parallel to its rear side (46) and has a tensioning and a relaxed position.

24. Inflatable textile bag (40) according to claim 23, wherein the holder and the tensioning device have common modules.

25. Inflatable textile bag (40) for lowering the drag of vehicles (30), having a vehicle side (47) and a rear side (46), wherein a holding apparatus (70) for fastening the inflatable textile bag (40) to a vehicle (30) is disposed on the vehicle side (47), and the inflatable textile bag (40) has a filled state and an emptied state, wherein the holding apparatus (70) comprises a stationary holding device (72) on the vehicle side and a sliding guide (73) on the inflatable textile bag side, which guide can particularly be displaced upward.

26. Inflatable textile bag (40) according to claim 25, wherein the sliding guide (73) comprises a sliding block guide (74).

27. Inflatable textile bag (40) according to claim 25, wherein the sliding guide (73) comprises a keder guide (75).

28. Inflatable textile bag (40) according to claim 27, wherein the keder guide (75) has two first keder rails (83) on the holding device side, which rails are spaced apart from one another either by the width or the height of the vehicle side (47), and has first keder rails (83) that reach over the height or the width of the vehicle side (47) accordingly, and, on the inflatable textile bag side, has keders (81) that are disposed in the first keder rails (83), at least in the filled state of the inflatable textile bag (40).

29. Inflatable textile bag (40) according to claim 28, wherein the two first keder rails (83) are aligned in a first plane, and the keder guide (75) has two second keder rails (84), which are disposed in a second plane that is angled away relative to the first plane, wherein in each instance, one of the second keder rails (84) is assigned, in each instance, to a first keder rail (83) and the associated keder (81), and the keder (81) can run from the first keder rail (83) into the second keder rail (84) and back.

30. Inflatable textile bag (40) according to claim 29, wherein a curved keder rail (85), which is preferably inclined in the direction of curvature, is disposed between at least one of the two first keder rails (83) and the associated second keder rail (84).

31. Inflatable textile bag (40) according to claim 27, wherein at least one of the keders (81) of the keder guide (75) has a keder flap (82), which is surrounded by a keder bead (86) and is connected with the inflatable textile bag (40).

32. Inflatable textile bag (40) according to claim 25, comprising a drive (61) for the sliding guide (73).

33. Inflatable textile bag (40) according to claim 32, wherein the drive (61) is active on both sides of the inflatable textile bag (40), parallel to the rear side (46).

34. Inflatable textile bag (40) according to claim 33, wherein the drive (61) comprises at least two drive motors, wherein one of the drive motors, in each instance, is disposed on one side of the inflatable textile bag (40), in each instance, and wherein one of the two drive motors is controlled as the master and the other of the two drive motors is controlled as the slave.

35. Inflatable textile bag (40) according to claim 32, wherein the drive (61) comprises a bidirectional winding drum (68) on which a circumferential cable (69) or two oppositely directed cables (69) are wound up alternately.

36. Inflatable textile bag (40) according to claim 35, wherein the cable (69) or the cables (69) is/are configured to be self-tensioning.

37. Inflatable textile bag (40) according to claim 32, wherein cables (69) are disposed on both sides of the inflatable textile bag (40) and/or the cables (69) and the inflatable textile bag (40), if applicable also with inclusion of a drive carriage (80), represent a circumferential drive cable.

38. Inflatable textile bag (40) for lowering the drag of vehicles (30), having a vehicle side (47) and a rear side (46), wherein a holding apparatus (70) for fastening the inflatable textile bag (40) to a vehicle (30) is disposed on the vehicle side (47), and the inflatable textile bag (40) has a filled state and an emptied state, wherein the inflatable textile bag (40) is connected with a venting device driven by the travel air stream of a motor vehicle.

39. Inflatable textile bag (40) according to claim 38, wherein the venting device is a filling and venting evacuation device (50) driven by the travel air stream.

40. Inflatable textile bag (40) according to claim 38, wherein the venting device comprises an air inlet (51), a Venturi nozzle (52) having a suction chamber (55) that is connected with the interior of the inflatable textile bag (40), and an air outlet (53).

41. Inflatable textile bag (40) according to claim 39, wherein a retention device (99) that optionally retains the air stream (57) flowing through the Venturi nozzle (52), and/or an opening (98) that can be selectively opened and closed into the suction chamber (55) is provided between the air inlet (51) and the air outlet (53), preferably between the Venturi nozzle (52) and the air outlet (53).

42. Inflatable textile bag (40) according to claim 40, wherein a filter arrangement (56) and/or a check valve (63) is/are provided between the air inlet (51) and the Venturi nozzle (52).

43. Inflatable textile bag (40) according to claim 40, wherein the air inlet (51) is configured to be conical.

44. Inflatable textile bag (40) according to claim 40, wherein means (49) for regulating the opening cross-section of the air inlet (51) are provided at the air inlet (51).

45. Inflatable textile bag (40) according to claim 37, wherein the drive carriage (80) carries the filling and/or venting device (50).

46. Inflatable textile bag (40) according to claim 1, comprising a heater (89).

47. Inflatable textile bag (40) according to claim 1, wherein the inflatable textile bag (40) and, in particular, its rear wall (42) are configured to be indivisible.

48. Inflatable textile bag (40) according to claim 1, wherein the inflatable textile bag (40) and, in particular, its rear wall (42) are configured to be divisible.

49. Inflatable textile bag (40) according to claim 48, wherein an openable and closable connection element is disposed at the division of the inflatable textile bag (40).

50. Inflatable textile bag (40) according to claim 1, comprising a quick-action vent, which comprises an openable and closable quick-action vent opening in a wall of the inflatable textile bag (40).

51. Inflatable textile bag (40) according to claim 49, wherein the openable and closable quick-action vent opening or the openable and closable connection element is provided on a connection line between surface elements, such as, for example, between stabilizer surface elements (3, 4, 5, 15, 16, 18) and/or inflatable bag surface elements (1, 2, 6, 7, 8, 9, 10, 11, 12, 13, 14, 17) among one another.

52. Inflatable textile bag (40) according to claim 49, wherein the openable and closable quick-action vent opening or the openable and closable connection element is represented by a two-component closure system, such as a zipper (39), a planar hook-and-loop closure or the like.
